(19) United States
(12) Patent Application Publication
(10) Pub. No.: US 2010/0077458 A1
(43) Pub. Date: Mar. 25, 2010

(54) Apparatus, System, and Method for Responsibility-Based Data Management

(75) Inventors: James A. Stout, Highland, UT (US); Howard B. Gee, Highland, UT (US)

Correspondence Address: FULBRIGHT & JAWORSKI L.L.P., 600 CONGRESS AVE., SUITE 2400, AUSTIN, TX, 78701, US

(73) Assignee: Card Access, Inc., SALT LAKE CITY, UT (US)

(21) Appl. No.: 12/237,752

(22) Filed: Sep. 25, 2008

(51) Int. Cl. G06F 21/00

(52) U.S. Cl. 726/4

(57) ABSTRACT

An apparatus, system, and method are disclosed for responsibility-based data management. In one embodiment, the method may include the steps of: (i) receiving, from a network participant, a request to access an information set; (ii) setting a permission indicator in response to a determination that the network participant is associated with a group dissemination attribute that authorizes the network participant to access the information set; (iii) modifying the permission indicator in response to a determination that an exception rule modifies the group dissemination attribute; (iv) setting the permission indicator in response to a determination that the network participant is associated with a system position attribute that authorizes the network participant to access the information set; and (v) providing access to the information set in response to a determination that the permission indicator authorizes the network participant to access the information set.

### FIELD OF THE INVENTION

This invention relates to data management and more particularly relates to an apparatus, system, and method for responsibility-based data management.

### DESCRIPTION OF THE RELATED ART

Groups or organizations of people working to achieve a common purpose or goal often face challenges with regard to adequate communication and sharing of information, responsibility delegation and tracking, and coordination of activities. In particular, data management may be one difficulty facing such groups and organizations.

Typical data management systems often require costly hardware acquisition and setup costs. As with most data management systems, data security may be a primary concern. Additional costs will often be incurred to employ a system administrator. Traditionally, a system administrator is an Information Technology (IT) professional that is trained to manage the data management system.

Ordinarily, a system administrator's duties include device and software configuration, security updates, setting system permissions, and the like. In general, a system administrator is a trained or experienced professional. A high degree of training or experience is often required for system administration because of the complexity of most hardware and software systems.

Database architecture and management may be an additional challenge facing such groups or organizations, particularly in organizations that require a high volume of data to be stored and disseminated according to a particular data dissemination scheme. A database administrator may be able to design and manage a database for handling such data, but database administration typically requires a different skill set than network or system administration. Therefore, such organizations may need to employ a dedicated database administrator in addition to the system administrator.

The costs associated with designing, procuring, configuring, and maintaining such complex data management systems may be unreasonable for small or informal organizations. For example, a religious or charitable organization may only require management of certain congregational records and financial records. Although data access and security is still a major concern for such records, it may be unfeasible for a small, non-profit organization to invest in costly data management systems and to employ the required IT professionals. In such situations, the security and/or organization of the information may be sacrificed to save costs.

Informal groups and organizations may face similar difficulties. For example, in a home healthcare setting, a group of individuals may be loosely organized for the purpose of managing the care of an elderly or ill individual. The group may include relatives of the elderly individual, including a spouse, children, grandchildren, or siblings. The group may also include home healthcare professionals such as nurses, aides, and physicians. The group may also include attorneys to handle testamentary documents, financial planners to assist in estate planning, accountants to handle accounting and tax planning, and the like.

Although it is unlikely that this type of loose organization of individuals would invest in a complex and costly data management system, effective communication and management of information may still be a problematic issue facing such groups. For example, a patient's guardian may want to share confidential medical records with some, but not all, of the other individuals in the group.

Similarly, a financial manager may wish to provide to certain individuals in the group access to financial accounts and information, so that they may have funds or information to accomplish certain tasks or to make certain payments. In this example, however, the financial manager may not wish to grant to all members of the group unrestricted access to the financial accounts and information. In these cases, disseminating access rights and sensitive account information in a coordinate and secure manner may be problematic.

In another example, the patient may have one or more sensors installed in his/her home for safety and health monitoring. For example, a camera, microphone, motion sensor, medical device sensor, or the like, may be installed in the patient's home. These sensors may generate a high volume of data on a continuous, or nearly continuous, basis. Management of this high volume of data would typically prove to be difficult without the assistance of a dedicated database administrator who is professionally trained to design and manage a database specifically architected for the sensor data. Unfortunately, the traditional database management systems and techniques would typically be cost prohibitive for such small groups or loose organizations.

The referenced shortcomings are not intended to be exhaustive, but rather are among many that tend to impair the effectiveness of previously known techniques for data dissemination; however, those mentioned here are sufficient to demonstrate that the methodologies appearing in the art have not been satisfactory and that a significant need exists for the techniques described and claimed in this disclosure.

### SUMMARY OF THE INVENTION

From the foregoing discussion, it should be apparent that a need exists for a method, system, and apparatus for responsibility-based data management.

A method, system, and apparatus for responsibility-based data management is disclosed. In one embodiment, the method may include the steps of: (i) receiving, from a network participant, a request to access an information set; (ii) setting a permission indicator in response to a determination that the network participant is associated with a group dissemination attribute that authorizes the network participant to access the information set; (iii) modifying the permission indicator in response to a determination that an exception rule modifies the group dissemination attribute; (iv) setting the permission indicator in response to a determination that the network participant is associated with a system position attribute that authorizes the network participant to access the information set; and (v) providing access to the information set in response to a determination that the permission indicator authorizes the network participant to access the information set.

In a further embodiment, step (ii) above may include the additional steps of: (a) identifying an association between the network participant and a group; (b) retrieving the group dissemination attribute associated with the information set; and (c) setting the permission indicator in response to a determination that the group dissemination attribute authorizes the network participant to access the information set based on the association between the network participant and the group.

In a further embodiment, step (iii) above may include: (a) locating an exception rule that applies to the network participant and to the information set; (b) modifying the permission indicator to deny the network participant access to the information set in response to a determination that the exception rule prohibits the network participant from accessing the information set; and (c) modifying the permission indicator to grant the network participant access to the information set in response to a determination that the exception rule authorizes the network participant to access the information set.

In a further embodiment, step (iv) above may include: (a) identifying a system position to which the network participant has been assigned; (b) retrieving the system position attribute associated with the system position; and (c) setting the permission indicator in response to a determination that the system position attribute authorizes the network participant to access the information set.

In one embodiment, the method may include tracking a transfer of a system position from a first network participant to a second network participant. The method may also include generating a log of service data associated with a system position.

A further embodiment of a method for responsibility-based data management may include: (i) receiving an information set for dissemination; (ii) setting a group dissemination attribute that authorizes a group of network participants to access the information set; (iii) establishing an exception rule configured to modify the group dissemination attribute in response to a special access requirement; and (iv) setting a system position attribute that authorizes a predetermined system position to access the information set.

In one embodiment, the method may include automatically setting the group dissemination attribute, establishing the exception rule, and setting the system position attribute. The method may also include storing the group dissemination attribute, the exception rule, and the system position attribute ascribed to the information set. Additionally, the method may include sending a notification to a predetermined network participant in response to a selected event associated with the information set.

An apparatus is also presented for responsibility-based data management. In one embodiment, the apparatus may include a receiver module configured to receive, from a network participant, a request to access an information set, and to provide access to the information set in response to a determination that a permission indicator authorizes the network participant to access the information set. The apparatus may also include an access module configured to set a permission indicator in response to a determination that the network participant is associated with a group dissemination attribute that authorizes the network participant to access the information set. Additionally, the apparatus may include an exception module configured to modify the permission indicator in response to a determination that an exception rule modifies the group dissemination attribute. In a further embodiment, the apparatus may include a responsibility module configured to set the permission indicator in response to a determination that the network participant is associated with a system position attribute that authorizes the network participant to access the information set.

In a further embodiment, the access module may also be configured to: (a) identify an association between the network participant and a group; (b) retrieve the group dissemination attribute associated with the information set; and (c) set the permission indicator in response to a determination that the group dissemination attribute authorizes the network participant to access the information set based on the association between the network participant and the group.

In another embodiment, the exception module may be configured to: (a) locate an exception rule that applies to the network participant and to the information set; (b) modify the permission indicator to deny the network participant access to the information set in response to a determination that the exception rule prohibits the network participant from accessing the information set; and (c) modify the permission indicator to grant the network participant access to the information set in response to a determination that the exception rule authorizes the network participant to access the information set.

In still another embodiment, the responsibility module may: (a) identify a system position to which the network participant has been assigned; (b) retrieve the system position attribute associated with the system position; and (c) set the permission indicator in response to a determination that the system position attribute authorizes the network participant to access the information set.

In a further embodiment, the responsibility module may include a tracking module configured to track a transfer of a system position from a first network participant to a second network participant. The responsibility module may also include a logging module configured to generate a log of service data associated with a system position.

The apparatus may also include a notification module configured to send a notification to a predetermined network participant in response to a selected event associated with the information set.

A further embodiment of an apparatus for responsibility-based data management may include a receiver module and an information set characterization module. In one embodiment, the receiver module may receive an information set for dissemination. The information set characterization module may: (a) set a group dissemination attribute that authorizes a group of network participants to access the information set; (b) establish an exception rule configured to modify the group dissemination attribute in response to a special access requirement; and (c) set a system position attribute that authorizes a predetermined system position to access the information set.

In one embodiment, the apparatus includes a data storage device. The data storage device may be configured to store the group dissemination attribute, the exception rule, and the system position attribute ascribed to the information set. In a first embodiment, the data storage device may be incorporated as a component of the apparatus in a single functional unit. In an alternative embodiment, the data storage device may be located remotely from the other modules of the apparatus, or from the apparatus itself.

For example, a system for responsibility-based data management may include a data storage device configured to store an information set, and a server coupled to the data storage device. The server and the data storage device may be either separated or integrated devices according to various embodiments of the system.

In one embodiment, the server may include a receiver module configured to receive, from a network participant, a request to access an information set, and to provide access to the information set in response to a determination that a permission indicator authorizes the network participant to access the information set. The server may also include an access module configured to set a permission indicator in response to a determination that the network participant is associated with a group dissemination attribute that authorizes the network participant to access the information set. Additionally, the server may include an exception module configured to modify the permission indicator in response to a determination that an exception rule modifies the group dissemination attribute. In a further embodiment, the server may include a responsibility module configured to set the permission indicator in response to a determination that the network participant is associated with a system position attribute that authorizes the network participant to access the information set.

In a further embodiment, the receiver module may receive an information set for dissemination. The server may additionally include an information set characterization module configured to: (a) set a group dissemination attribute that authorizes a group of network participants to access the information set for dissemination; (b) establish the exception rule configured to modify the group dissemination attribute in response to a special access requirement; and (c) set a system position attribute that authorizes a predetermined system position to access the information set for dissemination.

In a first embodiment, these various modules may be hardware-defined modules. For example, a module may include analogue or digital circuitry, programmable integrated circuit (IC) devices, Field Programmable Gate Array (FPGA) devices, or the like. The modules may be integrated with the server or incorporated in a peripherally coupled device. Alternatively, the modules may be software- or firmware-defined and configured to operate as functional modules executed by the server's processor.

As a result, a computer program product comprising a computer-readable medium having computer-readable instructions executable to perform operations for responsibility-based data management is also presented. In one embodiment, the operations may include: (i) receiving a request from a network participant to access an information set; (ii) determining whether the network participant is associated with a group dissemination attribute that authorizes the network participant to access the information set; (iii) determining whether an exception rule modifies the group dissemination attribute; and (iv) determining whether the network participant is associated with a system position attribute that authorizes the network participant to access the information set.

In a further embodiment, the computer program product may include instructions for receiving an information set for dissemination. The instructions may also include setting a group dissemination attribute that authorizes a group of network participants to access the information set for dissemination. In a further embodiment, the instructions may include establishing an exception rule configured to modify the group dissemination attribute in response to a special access requirement. In another embodiment, the instructions may include setting a system position attribute that authorizes a predetermined system position to access the information set for dissemination.

As used herein, the term “network” means a group of network participants working together to accomplish a defined cause, the network participants being in communication with an information management system that allows the network participants to efficiently exchange information related to that cause. For example, a “Home Care Network” is organized to focus on the care of an individual living at home and uses the system to connect people involved in the care of that individual, such as family members, doctors, neighbors, friends, clergy, and others.

As used herein, the term “network participant” means an individual or entity who has access to the data management system and participates in the network. In particular, the network participant may hold a username and login account to access the data management system.

As used herein, the term “information set” means the smallest piece of information within the network that can be enabled for access or blocked from being accessed by any relevant system position within the network. More specifically, an information set is data that is organized to be disseminated, as a unit, through the network to a network participant. The information set may include one or more bits, bytes, words, or complex constructs of data. An information set may also include a data object or file.

For example, an information set may contain data received from a grouping of five sensors located in a patient's home. Two of these sensors may be classified “sensitive,” and data from each of these sensitive sensors may be assigned to a first information set. Data from the other three sensors are grouped together as a second information set. Alternatively, individual bits received from the sensor may be stored as information sets. In another alternative embodiment, the information set may comprise a file (e.g., image, audio, or video). An information set may also be, for example, documents, password information, access to programs, access to web sites that allow the person accessing the web site to take certain actions (like transferring funds or purchasing stock), or account information.

As used herein, the term “group” means an assembly of network participants to which identical rights to access an information set, or information sets, is granted as a result of commonalities in the roles or relationships such network participants have to the fulfillment of the defined cause. For example, in a home care network, groups may include a “Siblings” group, a “Grandchildren” group, a “Neighbor” group, or a “Medical Team” group.

As used herein, the term “system position” means one of a variable number of organizational positions associated with defined responsibilities. The responsibilities associated with the system position may be defined within the network (e.g., by a network administrator or through a network setup wizard), with respect to each of which: (i) access to an information set is authorized on a set-by-set basis; (ii) authority is granted to publish, into the data storage device, information sets (with certain rights to share that authority with others); and (iii) responsibility for managing an information set associated with one or more designated information types may be assigned.

For example, in a home care network, a system position may be assigned to a person responsible for handling certain information types categorized as “medical”. As information of type “medical” is brought into the system, it would be the responsibility of the “medical” system position to evaluate and grant rights to publish into the system the “medical” information and to grant appropriate access of that information to the appropriate network participants. Such “medical-” related information would be the responsibility of the network participant assigned to the “medical” system position.

As used herein, the term “responsible person” means a network participant to whom a system position has been assigned.

As used herein, the term “network administrator” means a person or software process responsible for setting up and maintaining the network. For example, the network administrator may be responsible for: (i) adding, editing, and deleting groups, group members, and group information; (ii) adding, editing and deleting system positions and who is assigned to be the responsible person associated with the system position; (iii) adding, editing and deleting information types; and/or (iv) adding, editing and deleting network participants and network participant information.

As used herein, the term “information type” means a category of information for purposes of assigning such information to a responsible person for management. For example, in a home care network, information relevant to the network may be divided into information types that include legal information, medical information, insurance information, sensor information and financial information. In such an embodiment, each information type is assigned to a system position, which in turn is assigned to a responsible person.

As used herein, the term “information source” means an individual, organization, software process, or piece of equipment from which information to be stored in the data management system originates. The information may include automated data or non-automated data.

Automated data is automatically formatted and published in the data storage device through a translation device or process. The translation device or process may be configured by a responsible person, such as a network administrator. Examples of automated data include information from a sensor or any repeating data from a device or service.

Non-automated data is data that is unique each time it is published in the data storage device. Examples of non-automated data include insurance information reports, medical reports, legal documents, and work place phone lists.

As used herein, the term “group dissemination attribute” means a property, identifier, data value, meta-data, flag, or other indication of a relationship between a particular group and the information set with which the group dissemination attribute is associated.

As used herein, the term “exception rule” means a custom modification of a relationship between a designated member of a group and the information set, the relationship being established by the group dissemination attribute.

As used herein, the term “system position attribute” means a property, identifier, data value, meta-data, flag, or other indication of a relationship between a particular system position and the information set with which the system position attribute is associated.

As used herein, the term “notification attribute” means a property, identifier, data value, meta-data, flag, or other indication of a designated recipient of notifications associated with the information set.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and, in one non-limiting embodiment, “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended, linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram of one embodiment of a system for responsibility-based data management;

FIGS. 2A-2B are schematic block diagrams illustrating alternative embodiments of a system for responsibility-based data management;

FIG. 3 is a schematic block diagram illustrating one embodiment of a computing device for use in accordance with the present embodiments;

FIG. 4A is a schematic block diagram illustrating one embodiment of an apparatus for responsibility-based data management;

FIG. 4B is a schematic block diagram illustrating another embodiment of an apparatus for responsibility-based data management;

FIG. 5 is a schematic block diagram illustrating a further embodiment of an apparatus for responsibility-based data management;

FIG. 6 is a schematic flow chart diagram illustrating one embodiment of a method for responsibility-based data management;

FIG. 7 is a schematic flow chart diagram illustrating one embodiment of a method for storing information in a responsibility-based data management system;

FIG. 8 is a schematic block diagram illustrating one embodiment of a flow of operations in an apparatus for responsibility-based data management;

FIG. 9 is a schematic block diagram illustrating one embodiment of a flow of operations for storing an information set in an apparatus for responsibility-based data management;

FIG. 10 is a schematic block diagram illustrating one embodiment of a flow of operations for system position based access of an information set in an apparatus for responsibility-based data management;

FIG. 11 is a schematic block diagram illustrating one embodiment of a flow of operations for group-based access of an information set in an apparatus for responsibility-based data management;

FIG. 12 is a schematic block diagram illustrating another embodiment of a flow of operations for group-based access of an information set in an apparatus for responsibility-based data management;

FIG. 13 is a sensor layout diagram illustrating one embodiment of a home configured with sensors configured to automatically collect sensor data;

FIG. 14 is an organization chart illustrating one embodiment of a corporate organizational structure;

FIG. 15 is an organization chart illustrating one embodiment of group divisions within the corporate organization; and

FIG. 16 is an information flow chart illustrating one embodiment of assigning information types to system positions, and assigning system positions to network participants within a corporate organization.

### DETAILED DESCRIPTION

The invention and the various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations, including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present embodiments provide mechanisms and sets of tools to help groups of people, devices, or organizations assembled together in a common cause, to manage the data and responsibilities that are specific to that cause. Specifically, these embodiments provide for easy network setup and network maintenance. Using these various embodiments, adding network participants and creating a network structure may be easy and intuitive. Each network participant may belong to a group or set of groups, and may be given particular roles and responsibilities. Additionally, these embodiments may ensure that the data is secure and is distributed appropriately to eligible network participants. Examples of data that may be distributed may include automated sensor data, various document file formats, audio files (e.g., mp3, wav), picture files (e.g., jpg), video files (e.g., avi), automated email and fax data input, and others. Additionally, these embodiments may facilitate assignment of responsibilities which may be easily transferred from one network participant to another, and tracked over time.

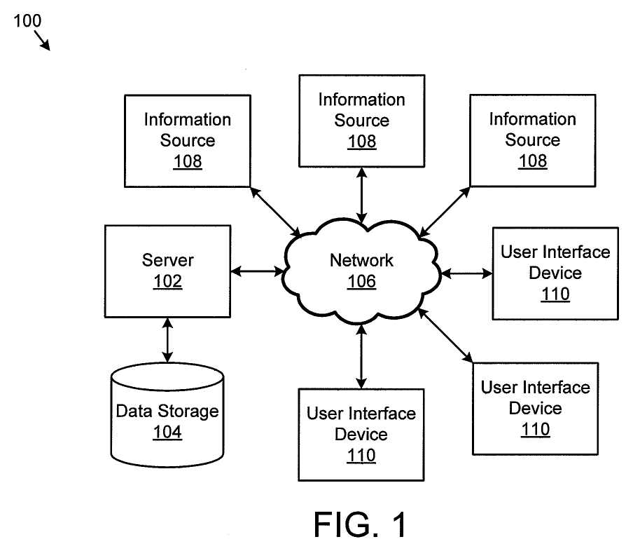

FIG. 1 is a schematic block diagram of one embodiment of a system 100 for responsibility-based data management. In one embodiment, the system 100 may include a network 106 comprising a server 102 coupled to a data storage device 104, and one or more information sources 108. In a further embodiment, the system 100 may include one or more user interface devices 110 configured to allow one or more network participants to access the server 102.

In one embodiment, the hardware configured to facilitate communications of the network 106 may include the Internet, a Local Area Network (LAN), a Wide Area Network (WAN), a wireless network, an ad-hoc network, or the like. Alternatively, the network 106 may include information communication services such as mail or postal services, email, fax, telephone, or the like.

The server 102 may function as a hub or gateway for communications in the network 106. Information communicated through the network 106 may be formatted via the server 102 and stored on the data storage device 104. For example, as described in greater detail below, the server 102 may assign a group dissemination attribute, an exception rule, and a system position attribute to data comprising an information set. Additionally, the server 102 may add a header field that may include a name or identifier for locating the information set, an information type assignment, and the like.

In one embodiment, the data storage device 104 may store one or more information sets. In a further embodiment, the data storage device 104 may store one or more of the group dissemination attribute, the exception rule, and the system position attribute with the information set. For example, the data storage device 104 may store an information set with associated meta-data, including the group dissemination attribute, the exception rule, and the system position attribute with the information set. Alternatively, the data storage device 104 may include a database configured to store one or more information sets and to associate the group dissemination attribute, the exception rule, and the system position attribute with the information set. In a further embodiment, the data storage device 104 may manage information sets in the system 100. The data storage device 104 may incorporate proven hardware and software, and techniques to store, backup, encrypt, and maintain data in the system 100. Alternatively, the server 102 may perform some or all of these data management tasks.

A data storage device 104 may include a hard disk, a floppy disk, a magnetic tape storage device, or an optical storage device (e.g., a CD, DVD, or holographic data storage medium). The data storage device 104 may be integrated with the server 102. Alternatively, the data storage device 104 may be coupled through a Storage Area Network (SAN) connection or other storage communication scheme such as a data bus, Fibre Channel Arbitrated Loop (FC-AL), high speed Ethernet, or the like. In a further embodiment, the data storage device 104 may include a plurality of data storage media configured in an array, such as a Redundant Array of Independent Disks (RAID) storage configuration.

As described above, an information source 108 may include an individual, organization, software process, or piece of equipment from which information to be stored in the data management system 100 originates. For example, an information source 108 may include a webcam, a motion sensor, a medical device, or an intercom installed in a patient's home. In a further embodiment, an information source 108 may include a web site, such as a banking site configured to provide electronic financial statements. The information source 108 may also include a fax system configured to transmit fax data to the server 102.

One of ordinary skill in the art will recognize that there are many types and configurations of information sources, and that it would not be reasonable to list every possible information source in the present disclosure. Therefore, the embodiments provided herein are not intended to be exhaustive or limiting, but only provide example embodiments to assist the reader in understanding the types of information sources that may be contemplated.

The information provided by the information source may include automated data or non-automated data. Automated data is automatically formatted and published in the data storage device through a translation device or process. The device or process may be configured by a responsible person, such as a network administrator. Examples of automated data include information from a sensor or other repeating data from a device or service. Non-automated data may include data that is unique each time it is published in the data storage device. Examples of non-automated data include insurance information reports, medical reports, legal documents, and work place phone lists.

A user interface device 110 may include a computer, such as a desktop workstation, a laptop, or notebook computer. Alternatively, a user interface device 110 may include a Personal Digital Assistant (PDA). In certain embodiments, the user interface device 110 may include a land-based telephone, a cellular telephone, a fax machine, or the like.

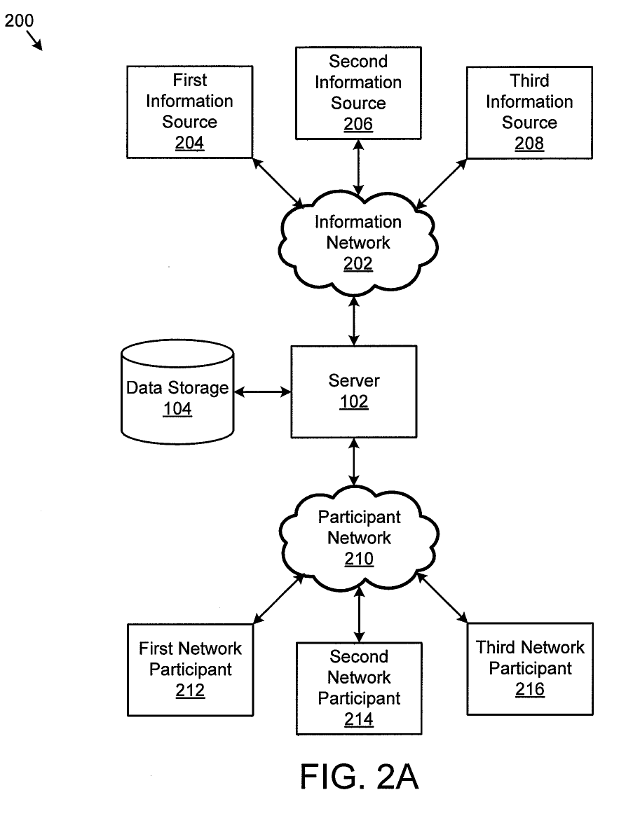

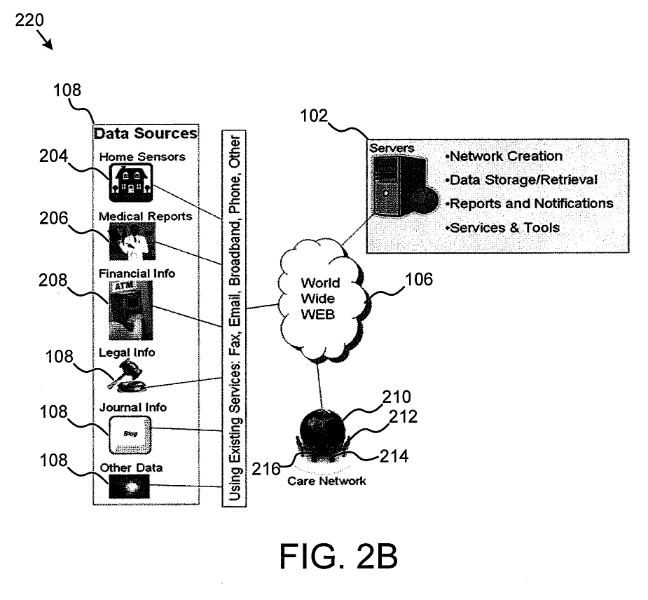

FIG. 2A is a schematic block diagram illustrating another embodiment of a system 200 for responsibility-based data management. In one embodiment, the system 200 may include a server 102 and a data storage device 104, as described above with reference to FIG. 1.

Additionally, the system 200 may include an information network 202 configured for communication of information from one or more information sources 204-208 to the server 102. For example, the information network 202 may include a first information source 204, a second information source 206, and a third information source 208. The information network 202 may include the network communication devices described above with relation to the network 106.

In a further embodiment, the system 200 may include a network participant network 210. According to one embodiment, the network participant network 210 may represent an organization or relationship of network participants 212-216. In one example embodiment, the network participant network 210 may include a first network participant 212, a second network participant 214, and a third network participant 216. For example, in a network participant network 210 organized for patient care, the first network participant 212 may include a relative of the patient, the second network participant 214 may include a medical professional, and the third network participant 216 may include a service professional, such as an aide.

In a further embodiment, the network participant network 210 may include hardware and infrastructure components configured to facilitate communications between the network participants 212-216 and the server 102. For example, the network participant network 210 may include the network communication devices described above with relation to the network 106. In particular, the network participant network 210 may include one or more user interface devices 110.

FIG. 2B illustrates a further embodiment of a system 220 for responsibility-based data management. In this example embodiment, the system 220 may include a network 106 configured to facilitate communications over the World Wide Web (WWW) between a server 102, one or more information sources 108, and one or more network participants 212-216 in a network participant network 210 organized for the care of an elderly individual. In such an embodiment, the network 106 may facilitate communications between all information sources 108, 204-208, the network participants 212-216, and the server 102. In this embodiment, the network participant network 210 may be merely an organizational tool for defining roles and responsibilities related to the specified task.

In one embodiment, the system 220 may include various information sources 108. For example, a first information source 204 may include a sensor installed in the home of an individual or in a business or manufacturing setting. A second information source 206 may include medical reports communicated by a medical professional. The third information source 208 may include financial information communicated by a financial institution, such as a bank. Additional information sources 108 may provide legal information, journal information, and various other types and formats of data.

In this embodiment, the server 102 may facilitate creation of the network participant network 210, data storage and retrieval, reporting and notification, and various other services and tools that may be specified by the network participant network 210 or a network administrator. In a particular embodiment, a first network participant 212 may be assigned to the system position of network administrator. Since the server 102 may include various network intuitive configuration tools, such as wizards, automated forms, Graphical User Interfaces (GUIs), and automated configuration processes, it may not be necessary for the network administrator 212 to be professionally trained as a system or database administrator.

For example, the server 102 may include a GUI comprising interactive fields or a wizard configured to prompt the network administrator 212 for information necessary to add or remove network participants from the network participant network 210. The server 102 may additionally prompt the network administrator to add, delete, or modify groups. Additionally, the server 102 may automatically configure group dissemination attributes for association with information sets in response to configuration information received from the network administrator 212. In a further embodiment, the server 102 may include GUIs, forms, or wizards for adding, editing and deleting system positions and who is assigned to be the responsible person associated with the system position. Similarly, the server 102 may include GUIs, forms, or wizards for adding, editing and deleting information types.

In a particular embodiment, the server 102 may include one or more network configuration templates. For example, a simple user questionnaire may be used to query the network administrator 212 about how he would like to use the system 200. This questionnaire query may then direct the network administrator 212 to select one of several recommended default templates that may be preconfigured in the system 200 for use.

The system 200 may be architected to operate in accordance with an operational template that allows the system 200 to provide different levels of service. In one embodiment, the parameters of the system 200 may be able to change based on the level of service that the network administrator 212 has chosen to purchase. For example, the system 200 may be capable of applying ten or more operational templates. The items that may be configurable may include the number of network participants, the number of information types, the number of system positions, the number of groups, the amount of historical data that may be stored by the system data storage device 104, the number of files that may be maintained in the system 200, the types of files that may be maintained, the number of information sources 108, the number of notifications, the number and types of reports that are available, and other system functionality parameters, such as scheduling, responsibility tracking, and the like.

The server 102 may also include components configured for automated notification of network participants 212-216 concerning additions, deletions, or modifications of information sets, system positions, groups, and other events related to the network. In still another embodiment, the server 102 may include scheduling, budgeting, and progress tracking processes and reports. Additionally, the server 102 may track responsibilities for certain tasks.

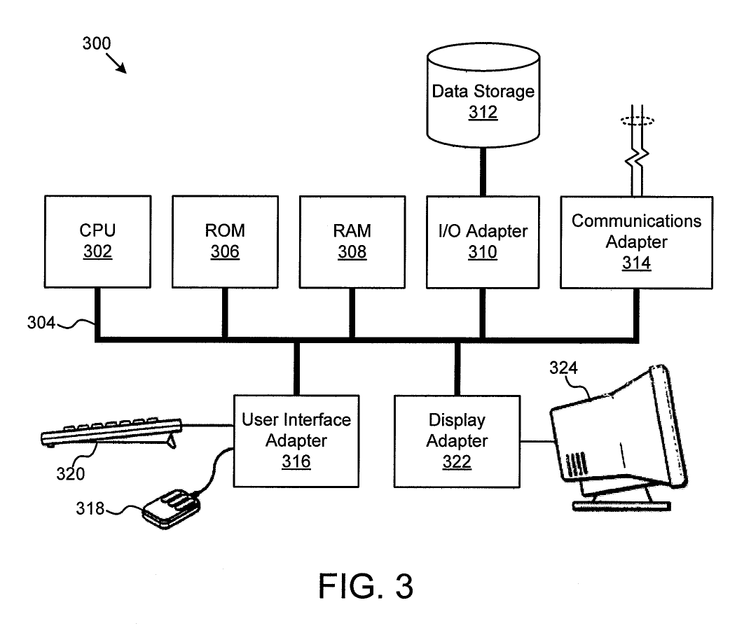

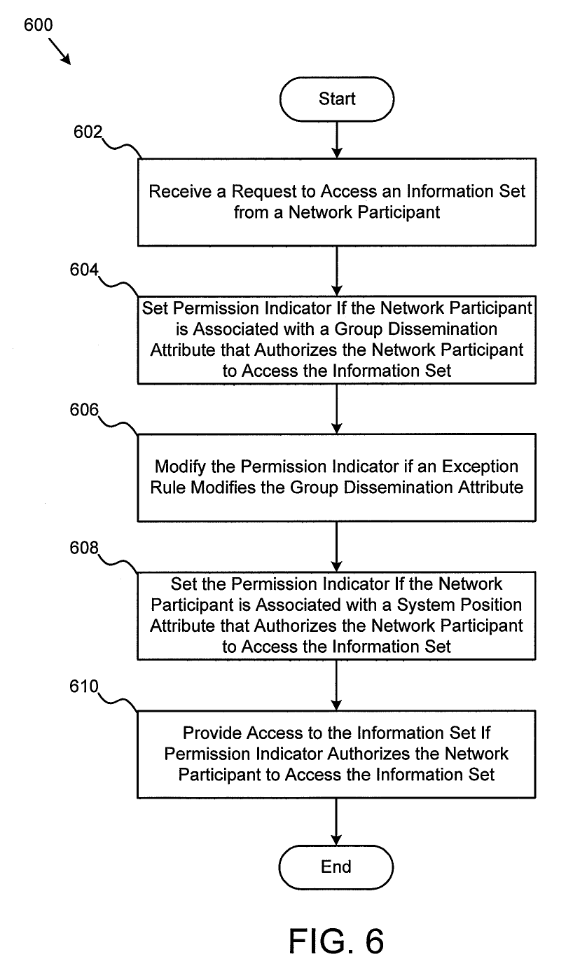

FIG. 3 illustrates a computer system 300 adapted according to certain embodiments of the server 102. The central processing unit (CPU) 302 may be coupled to the system bus 304. The CPU 302 may be a general purpose CPU. The present embodiments are not restricted by the architecture of the CPU 302 as long as the CPU 302 supports the modules and operations as described herein. The CPU 302 may execute the various logical instructions according to the present embodiments. For example, the CPU 302 may execute machine-level instructions according to the exemplary operations described below with reference to FIGS. 6-12.

The computer system 300 may also include Random Access Memory (RAM) 308, which may be SRAM, DRAM, SDRAM, or the like. The computer system 300 may utilize RAM 308 to store the various data structures used by a software application configured for responsibility-based data management. The computer system 300 may also include Read Only Memory (ROM) 306 which may be PROM, EPROM, EEPROM, or the like. The ROM may store configuration information for booting the computer system 300. The RAM 308 and the ROM 306 may hold user and system 100 data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300 in order to input information for network configuration and add information sets to the data storage device 104. In a further embodiment, the display adapter 322 may display a graphical user interface associated with a software or web-based application for responsibility-based data management.

The I/O adapter 310 may connect to one or more storage devices 312, such as one or more hard drives, Compact Disk (CD) drives, floppy disk drives, or tape drives, coupled to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather, the computer system 300 is provided as an example of one type of computing device that may be adapted to perform the functions of the server 102 and the user interface devices 110. For example, any suitable processor-based device may be utilized, including without limitation, PDAs, computer game consoles, and multi-processor servers. Moreover, the present embodiments may be implemented on application-specific integrated circuits (ASIC) or very large scale integrated (VLSI) circuits. In fact, persons of ordinary skill in the art may utilize any number of suitable structures capable of executing logical operations according to the described embodiments.

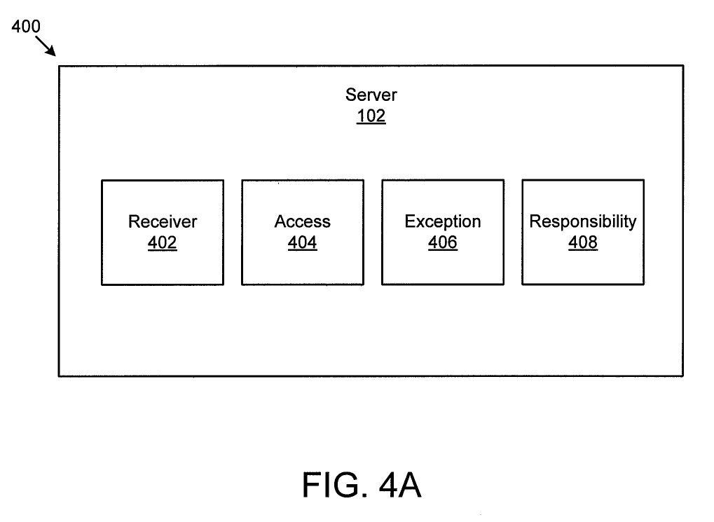

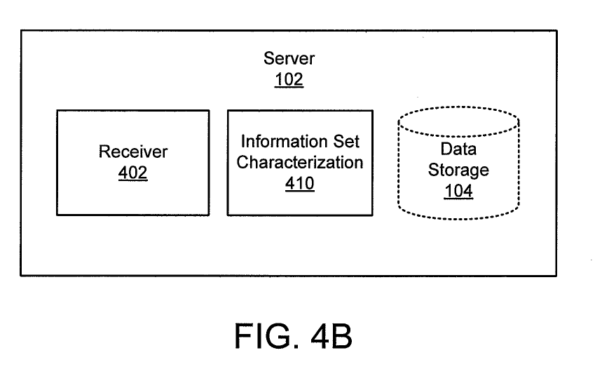

FIG. 4A is a schematic block diagram illustrating one embodiment of an apparatus 400 for responsibility-based data management. In one embodiment, the apparatus 400 may be a server 102. Alternatively, the apparatus 400 may include a peripheral data management device coupled to the server 102. In still other embodiments, the apparatus 400 may include a storage management device, a storage server, a web server, an application server, or the like.

In one embodiment, the apparatus 400 may include a receiver module 402 configured to receive a request to access an information set from a network participant 212. The receiver module 402 may act as a gateway for accessing the information set. For example, the receiver module 402 may also provide access to the information set in response to a determination that a permission indicator authorizes the network participant 212 to access the information set.

The apparatus 400 may also include an access module 404 configured to determine whether the network participant 212 is associated with a group dissemination attribute that authorizes the network participant 212 to access the information set. If the network participant 212 is associated with the group dissemination attribute, the access module 404 may set the permission indicator to authorize the network participant 212 to access the information set. Alternatively, if the network participant 212 is not associated with the group dissemination attribute, the access module may set the permission indicator to prohibit the network participant 212 from accessing the information set.

The permission indicator may include a register configured to receive a certain predetermined value or set of values, a bit stored in memory, a latched value, or the like. Additionally, the permission indicator may include a software-defined flag or transistor value configured to indicate that permission is granted or denied.

Additionally, the apparatus 400 may include an exception module 406 configured to determine whether an exception rule modifies the group dissemination attribute. If an exception rule does modify the group dissemination attribute or the permissions authorized by the group dissemination attribute, then the exception module 406 may modify the permission indicator. For example, the exception module 406 may modify a register value.

In a further embodiment, the apparatus 400 may include a responsibility module 408 configured to determine whether the network participant 212 is associated with a system position attribute that authorizes the network participant 212 to access the information set. If the system position attribute does authorize the network participant 212 to access the information set, the responsibility module 408 may set the permission indicator to authorize access to the information set. In one embodiment, the permission indicator set by the responsibility module 408 may be the same as the permission indicator set by the access module 404 and the exception module 406. Alternatively, each module 404-408 may set separate or distinct permission indicators, and the receiver module 402 may check each of the permission indicators.

In a first embodiment, these various modules 402-408 maybe hardware-defined modules. For example, a module may include analogue or digital circuitry, programmable integrated circuit (IC) devices, Field Programmable Gate Array (FPGA) devices, or the like. The modules 402-408 may be integrated with the server 102 or incorporated in a peripherally coupled device. Alternatively, the modules may be software- or firmware-defined and configured to operate as functional modules executed by the server's processor 302.

In one embodiment, the receiver module 402 may receive a request from a network participant 212 to view, print, or otherwise access information that is contained in the data storage device 104. Additionally, the receiver module 402 may pass the request along to the access module 404. In a further embodiment, the receiver module 402 may also pass the request to the responsibility module 408. In one embodiment, the receiver module 402 may pass the request to both the access module 402 and the responsibility module 408 in parallel, so that both modules 404, 408 may determine whether the network participant 212 is authorized to access the information set in a substantially simultaneous manner.

In one embodiment, the receiver module 402 includes the I/O adapter 310. In a further embodiment, the receiver module 402 includes the communications adapter 314. Alternatively, the receiver module 402 may include communication ports, pins, or pads configured to couple the processor 302 to the I/O adapter 310 and/or the communications adapter 314. The receiver module 402 may additionally include a software-defined module configured to cause the processor 302 to receive information sets and requests from the I/O adapter 310 and/or the communications adapter 314. Alternatively, the receiver module 402 may include a gateway device that is peripherally or integrally coupled to the server 102 and/or the remaining modules of the apparatus 400.

In still another embodiment, the receiver module 402 may receive determinations regarding the authorization of a requesting network participant 212 to access a designated information set from the exception module 406 and/or the responsibility module 408. Additionally, the receiver module 402 may permit the network participant 212 to access to the designated information set in response to a determination that the network participant 212 is authorized to access the information set. The receiver module 402 may permit the access in response to a value of the permission indicator that allows access. In such an embodiment, the receiver module 402 acts as a gateway to the system for network participants 212-216 requesting information.

In one embodiment, the access module 404 may also be configured to: (a) identify an association between the network participant 212 and a group; (b) retrieve the group dissemination attribute associated with the information set; and (c) set the permission indicator in response to a determination that the group dissemination attribute authorizes the network participant 212 to access the information set.

For example, the access module 404 may receive a request from a network participant 212 to access a designated information set from the receiver module 402. The access module 404 may then determine to which group the network participant 212 who has requested access to such an information set has been assigned. Additionally, the access module 404 may determine whether that specific group has been authorized to access the requested information set by retrieving the group dissemination attribute that has been ascribed to the information set. In a further embodiment, the access module 404 may, for example, compare a value of the group dissemination attribute against an access table stored in memory 308 to determine whether the network participant 212 is authorized to access the information set. Alternatively, the group dissemination attribute may contain an identifier associated with the one or more groups that are authorized to access the information set. Finally, the access module 404 may communicate that determination to the exception module 406.

In one embodiment, the exception module 406 may be configured to locate an exception rule that applies to the network participant 212 and to the information set. Additionally, the exception module 406 may deny the network participant 212 access to the information set in response to a determination that the exception rule prohibits the network participant 212 from accessing the information set. Alternatively, the exception module 406 may grant the network participant 212 access to the information set in response to a determination that the exception rule authorizes the network participant 212 to access the information set. In one embodiment, the exception module 406 may grant or deny the access by modifying the permission indicator or setting a separate permission indicator.

For example, the exception module 406 may determine, track, and manage exception rules that have been ascribed to a particular information set. The exception rules may be created by a network administrator, a responsible person, or through an automated configuration or formatting process performed in response to certain predefined global rules and attributes. In a further embodiment, the exception module 406 may include user interfaces and/or wizards for generating exception rules.

An exception rule may override the authority granted by the group dissemination attribute. Therefore, once the access module 404 determines whether a network participant 212 has access or no access to a particular information set based on the group to which such network participant 212 has been assigned, the exception module 406 may determine whether an exception rule has been established with respect to the relationship between the network participant 212 and the designated information set. In a further embodiment, the exception module 406 may communicate to the receiver module 402 the results of that determination.

In one embodiment, exception rules may be used to deny a network participant 212 access to a particular information set, when such network participant 212 would otherwise have access to such information set. Alternatively, the exception rule may grant a network participant 212 access to a particular information set, when such network participant 212 would otherwise not have access to such information set based on the group dissemination attribute.

In still another embodiment, the access module 404 and exception module 406, together, may be used to present to a network participant 212 a listing of information sets the group to which such network participant has been assigned may access, subject to any exception rules specific to that network participant 212.

In one embodiment, the responsibility module 408 may identify a system position to which the network participant 212 has been assigned. Additionally, the responsibility module 408 may retrieve the system position attribute ascribed to the information set. In a further embodiment, the responsibility module 408 may set the permission indicator in response to a determination that the system position attribute authorizes the network participant 212 to access the information set.

For example, in a manner similar to, but independent of, the access module 404, the responsibility module 408 may receive from the receiver module 402 a request from a network participant 212 to access a designated information set. The responsibility module 408 may then determine whether the network participant 212 is a responsible person and, if so, which system position(s) has/have been assigned to the network participant 212. The responsibility module 408 determines whether such system position(s) has/have been authorized to access the requested information set. Additionally, the responsibility module 408 may communicate that determination to the receiver module 402. This portion of the responsibility module 408 may also be used to present to a network participant 212 a listing of all information sets the system position(s) assigned to such network participant 212 may access.

The access module 404, exception module 406, and responsibility module 408 may include a hardware-defined circuit card, including digital and/or analogue logic, microprocessors, programmable chips, or the like coupled to the processor 302. For example, the access module 404 may include a memory device configured to store the one or more attributes and rules, and a network of one or more digital or analogue comparison gates configured to compare stored bit values associated with the network participant and the attributes and rules associated with the network participant 212. Alternatively, the access module 404 may include a software-defined module configured to cause the processor 302 to perform the operations of the access module 404, exception module 406, and responsibility module 408.

FIG. 4B is a schematic block diagram illustrating another embodiment of a server 102. In the depicted embodiment, the server 102 includes a receiver module 402 and an information set characterization module 410. The receiver module 402 may receive an information set for dissemination. For example, the receiver module 402 may receive the information set from a network participant 212-216, or from an automated information source 108.

In one embodiment, the information set characterization module 410 may receive the information set for dissemination. The information set characterization module 410 may also designate the group dissemination attribute that authorizes a group of network participants 212-216 to access the information set. The information set characterization module 410 may further establish the exception rule configured to modify the group dissemination attribute in response to a special access requirement. In a further embodiment, the information set characterization module 410 may designate the system position attribute that authorizes a predetermined system position to access the information set.

For example, the information set characterization module 410 may ascribe to an information set published in the data storage device 104 the access rights identified by the group dissemination attribute, the exception rule, and the system position attribute. Specifically, the information set characterization module 410 may assign values to these attributes and rules. Through the use of the information set characterization module 410, a responsible person 212 who publishes an information set in the data storage device 104 may determine which groups will have access, and which groups will not have access, to the information set, determine whether any individual exception rules should be created as a result of such group designations (that is, whether a network participant 212 who is in an authorized group should be denied access to such information set, or whether a network participant 212 who is not in an authorized group should be permitted access to such information set), and determine which, if any, system positions should be granted access to such information set. Alternatively, the information set characterization module 410 may accomplish these tasks in accordance with certain global attributes and rules.

In a further embodiment, the information set characterization module 410 may designate the manner, if at all, in which the information set, or notice that the information set has been published in the data storage device 104, will be sent to those network participants 212-216 that may access the information set. In still a further embodiment, the information set characterization module 410 may provide “header” (summary descriptive) information regarding the information set, including, but not limited to, the information type, and an identifier for the information set.

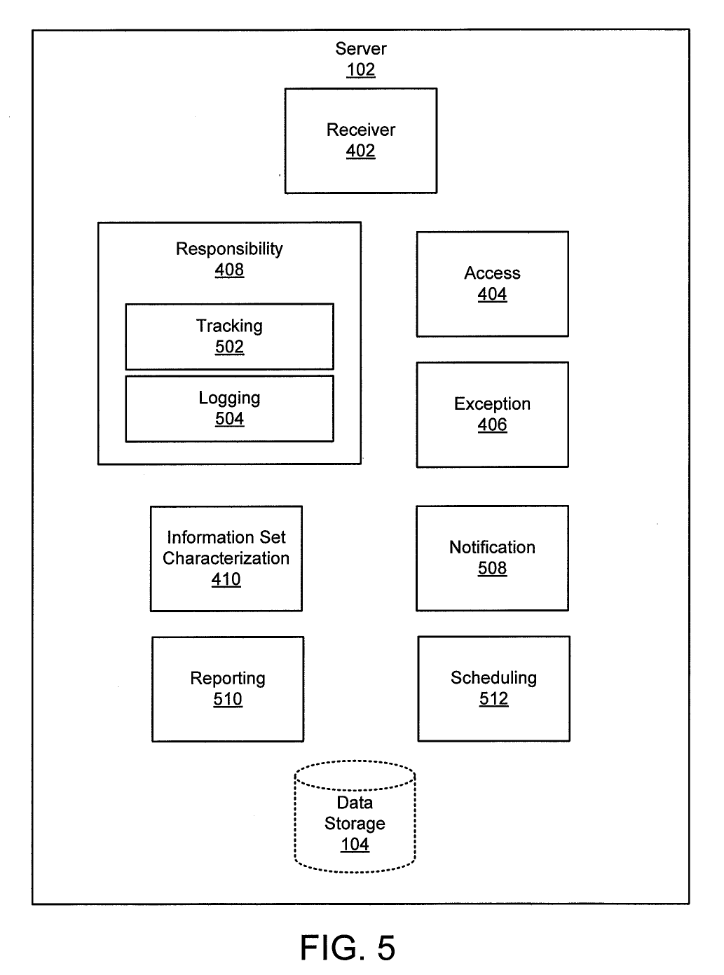

FIG. 5 is a schematic block diagram illustrating another embodiment of a server 102 configured for responsibility-based data management. In the depicted embodiment, the server 102 may include the receiver module 402, the access module 404, the exception module 406, and the responsibility module 408, substantially as described above with relation to FIG. 4. In a further embodiment, the responsibility module 408 may include a tracking module 502 and a logging module 504. The server 102 may additionally include an information set characterization module 410 and a notification module 508. In a further embodiment, the data storage device 104 may be integrated with the server 102.

In one embodiment, the responsibility module 408 may include a tracking module 502 configured to track a transfer of a system position from a first network participant 212 to a second network participant 214. For example, the tracking module 502 may oversee the assignment of information types to system positions and system positions to network participants 212-216. In a further embodiment, the tracking module 502 may facilitate the transfer of system positions, on both temporary and permanent basis, from a first network participant 212 to a second network participant 214. In still another embodiment, the server 102 may include a reporting module 510 and a scheduling module 512.

For example, a system position may have unique access to encrypted data in the data storage device 104 which is used to store information that is specific to the responsibilities associated with the system position. The data storage device 104 may store valuable information that can be transferred from one responsible person 212 to another responsible person 214 as the system position is transitioned from one network participant 212 to another network participant 214. For example, if the first network participant 212 holds the system position of “Financial Manager,” the data storage device 104 may contain valuable account and login information used in managing the financial assets of the network. If the system position of “Financial Manager” is transferred to the second network participant 214, then that information becomes available to the second network participant 214 when this system position is assigned to her.

In one embodiment, a responsible person 212 may create and modify network participant information. In a further embodiment, a responsible person 212 may view the network structure, system position assignments, group assignments, and view individual information relating to network participants 212-216.

The tracking module 502 may also manage delegation of responsibilities in the network participant network 210. For example, a responsible person 212 may delegate his/her system position to another network participant 214. This may be done on a permanent basis, which means that, after execution, he/she may lose access to the information and the rights associated with that system position (full responsibility transfer), or may be done as a shared access, granting delegable rights to another network participant 214 (e.g., an assistant) to share in the completion of the day-to-day management duties, while still retaining full responsibility. For example, shared access may include granting access to the information sets in the data storage device 104 (as a trusted assistant), or by not granting access to the information sets in the data storage device 104. In these various embodiments, the tracking module 502 may track changes to system positions by updating the system position attribute associated with the information sets.

In a further embodiment, a responsible person 212 may delegate full responsibility associated with his/her system position to another network participant 214 for a set amount of time to expire on “X” date, while still retaining shared access rights (like a delegable assistant). Alternatively, the responsible person 212 may delegate a permanent responsibility change to another network participant 214 to take effect on “X” date (full responsibility transfer). These transfers of responsibility may be facilitated and tracked automatically by the tracking module 502. For example, the tracking module 502 may update the system position attributes associated with information sets that are tied to the system position. In such an embodiment, the system position attribute may be updated to identify the second network participant 214 rather than the first network participant 212.

The responsibility module 408 may also include a logging module 504 configured to log service data associated with a system position. For example, the logging module 504 may chronicle both the points in time each network participant 212-216 was assigned any system position, and a history of actions and events associated with the network participants 212-216 to which each system position is assigned. The logging module 504 may also record a history of transfers of system positions between network participants 212-216.

In one embodiment, the server 102 may include an information set characterization module 410 in addition to the access module 404, the exception module 406, and the responsibility module 408. In such an embodiment, the server 102 may receive and store information sets for dissemination through the receiver module 402 and may designate attributes and rules, format the information set and store the information set in the data storage device 104 using an information set characterization module 410. The information set characterization module 410 may operate substantially as described above with reference to FIG. 4B. Additionally, the server 102 may provide access to the information set through the access module 404, the exception module 406, and the responsibility module 408.

The server 102 may also include a notification module 508 configured to send a notification to a predetermined network participant 212 in response to a selected event associated with the information set. For example, the notification module may be responsible for notifying network participants 212-216 of various events associated with the network 106. A notification may be sent to a network participant 212-216 in a variety of ways and may be sent in association with events that occur within the network 106. For example, when a document is published into the network 106, a notification may be sent to a network participant 212 via an email, text message, or some other notification method. Notifications may also be sent to network groups as well as a single network participant 212. Another example may include a notification sent to a network participant 212-216 when a sensor detects that door has opened or closed. The notification module 508 may obtain information from a notification attribute ascribed to the information set to determine how notifications should be conducted. The notification attribute may be set by a responsible person 212, or set automatically by the information set characterization module 410 in accordance with certain predetermined global attributes and rules.

Notifications may be categorized into two types: first, those that are sent automatically (automated notifications) based on rules that are previously established or set up by a responsible person 212 or the information set characterization module 410; and second, those that occur real time, as requested by a network participant 212-216 (non-automated notification).

In a further embodiment, the notification module 508 may include separate modules configured to handle the non-automated and automated notifications. The non-automated notification module (not shown) may be used to manually notify network participants 212-216 when an information set to which they have been granted access is published into the data storage device 104 by the responsible person 212. The non-automated notification module may allow a network participant 212 to send notifications to another network participant 214 on a case-by-case basis as events occur.

In one embodiment, the automated notification module (not shown) may notify network participants 212-216 when certain defined conditions within an automated information set are met. The automated notification module may allow the network participants 212-216 to customize the extent to which they receive notifications and the method by which those notifications are made.

In a further embodiment, the server 102 may include a reporting module 510 configured to generate reports for use by the network administrator, responsible persons, and other network participants 212-216. For example, the reporting module 510 may query a database of information sets stored on the data storage device 104 to determine a list of information sets that the first network participant 212 is authorized to access. In an alternative embodiment, the access module 404, the exception module 406, and the responsibility module 408 may make a series of determinations based on group dissemination attributes, exception rules, and system position attributes, and provide information regarding those determination to the reporting module 510 for creation of the same report. The reporting module 510 may be configured to provide a variety of other reports, including a list of pending responsibilities, and the like. In a further embodiment, the reporting module 510 may provide graphical charts, such as pie charts for tracking task distribution, venn diagrams for responsibility or group distributions, and the like.

In a further embodiment, the server 102 may include a scheduling module 512. The scheduling module 512 may coordinate information from the tracking module 502, and other information entered by network participants 212-216, to generate one or more schedules for accomplishing tasks or goals. The scheduling module 512 may further provide task lists, and automated notifications through the notification module 508. In one embodiment, a schedule may include a timeline, a Gantt chart, a calendar, a PERT chart, or the like.

In one embodiment, the server 102 includes a data storage device 104. The data storage device 104 may be configured to store the group dissemination attribute, the exception rule, and the system position attribute ascribed to the information set. In a first embodiment, the data storage device 104 may be incorporated as a component of the server 102 in a single, functional unit. In an alternative embodiment, the data storage device 104 may be located remotely from the other modules of the server 102, or from the server 102 itself.

In certain further embodiments, the server 102 may include an interactive user interface control (not shown) for disabling or disengaging certain of the modules. For example, a user may select an option to disable the exception module 406, so that the default group dissemination attributes control dissemination of the information set. In a further embodiment, the user interactive control may provide an option for disabling the responsibility module 408 and associate responsibility tracking. In another example, the user interface control may provide an option for disabling the notification module 508, the logging module 504, or other modules of the server 102. The interactive user interface control may comprise a GUI, an interactive web page or form, a mechanical control comprising buttons and/or switches, or the like.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 6 is a schematic flow chart diagram illustrating one embodiment of a method 600 for responsibility-based data management. In one embodiment, the method 600 starts when the receiver module 402 receives 602 a request to access an information set from a network participant 212 in a network 210. The method 600 may continue when the access module 404 determines 604 whether the network participant 212 is associated with a group dissemination attribute that authorizes the network participant 212 to access the information set. In a further embodiment, the exception module 406 may determine 606 whether an exception rule modifies the group dissemination attribute. Additionally, the responsibility module 408 may determine 608 whether the network participant 212 is associated with a system position attribute that authorizes the network participant 212 to access the information set.

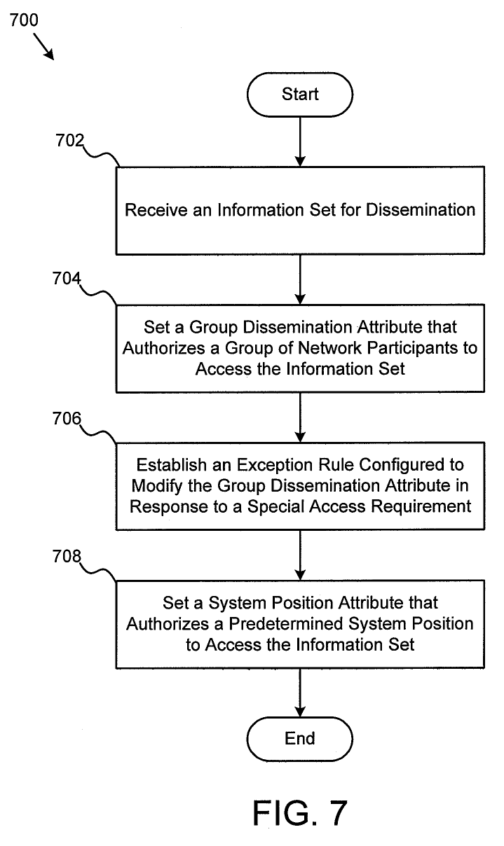

FIG. 7 is a schematic flow chart diagram illustrating one embodiment of a method 700 for storing information in a responsibility-based data management system 100, 200, 220. In one embodiment, the receiver module 404 may receive 702 an information set for dissemination. The information set characterization module 410 may then designate 704 a group dissemination attribute that authorizes a group of network participants 212-216 to access the information set. In one embodiment, the group may include multiple network participants 212-216. Alternatively, the group may only include a single network participant 212.

The information set characterization module 410 may additionally establish 706 an exception rule configured to modify the group dissemination attribute in response to a special access requirement. For example, a network administrator or responsible person 212 may identify one or more network participants 214-216 that are authorized to access the information set despite an access restriction based on the group to which the network participants 214-216 belong. Alternatively, the exception rule may limit access where it would ordinary be granted.

In a further embodiment, the information set characterization module 410 may designate 708 a system position attribute that authorizes a predetermined system position to access the information set, and the method 700 ends. In certain further embodiments, the information set characterization module 410 may also set a notification attribute to identify recipients of notifications associated with the information set.

In one embodiment, the information set characterization module 410 may perform steps 704-708 in response to user input from a network administrator or a network participant 212. Alternatively, the information set characterization module 410 may perform steps 704-708 automatically in response to certain predetermined global attributes and rules.

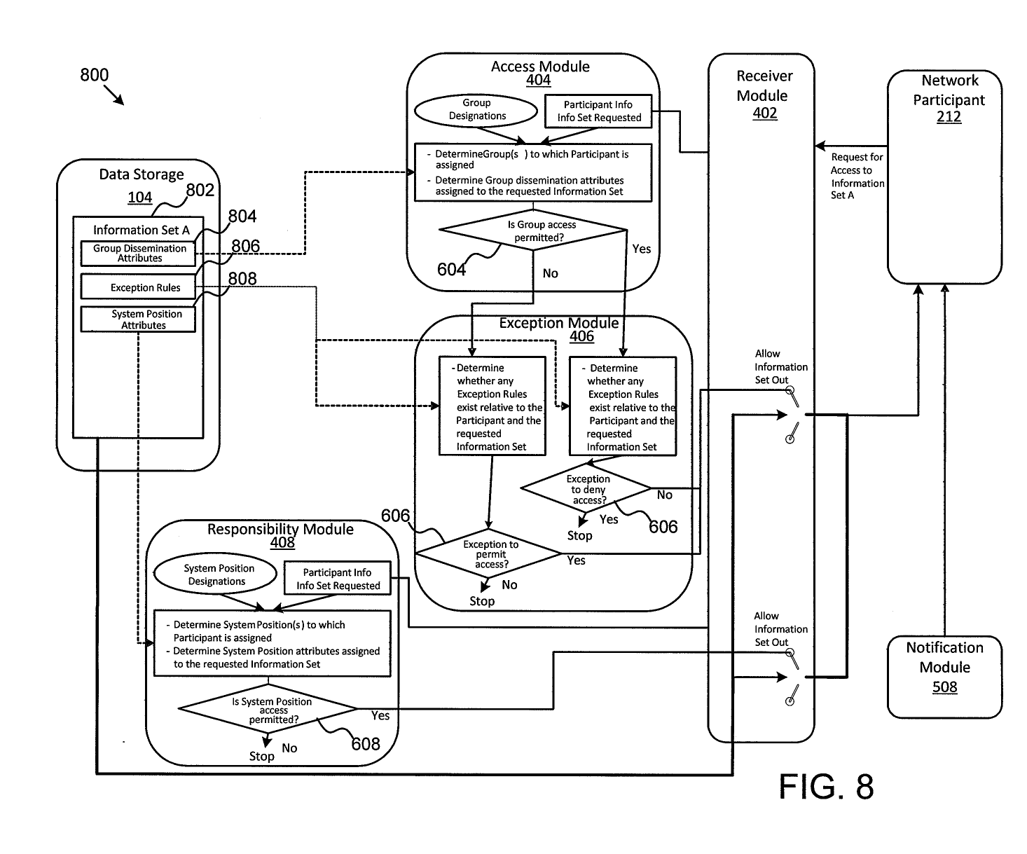

FIG. 8 is a schematic block diagram illustrating one embodiment of a flow of operations in an apparatus 800 for responsibility-based data management. In the described embodiment, the apparatus 800 may include a receiver module 402, an access module 404, an exception module 406, and a responsibility module 408. In a further embodiment, the apparatus 800 may include a notification module 508. The apparatus 800 may include a data storage device 104. Alternatively, the data storage device 104 may be located remotely.

In the depicted embodiment, the network participant 212 may send a request to access an information set 802 to the receiver module 402. The receiver module 402 may then communicate the request to the access module 404 and the responsibility module 408 at substantially the same time.

The access module 404 may include a table of group designations that correlates individual network participants 212-216 with various groups in the system. The access module 404 may also include stored information regarding the network participant 212. In this embodiment, the access module 404 may use the group designations and the network participant 212 information to determine the groups to which the network participant 212 has been assigned. The access module 404 may further use the group dissemination attribute 804 retrieved from the information set 802 to determine 604 whether group access is permitted.

Once the access module 404 determines 604 whether group access is permitted, the exception module 406 may determine whether any exception rule 806 exists that would modify permissions set by the group dissemination attribute. If an exception rule 806 does exist, the exception module 406 may determine 606 whether the exception rule restricts or allows the network participant 212 to access the information set 802.

In one embodiment, the responsibility module 408 may make an independent determination 608 of whether the network participant 212 is authorized to access the information set 802 based on a system position attribute 808 stored on the data storage device 104 and ascribed to the information set 802. Like the access module 404, the responsibility module 408 may include a table of network participant information. The responsibility module 408 may also include a table that correlates one or more network participants 212-216 to one or more system positions. The responsibility module 408 may determine the network participant's 212 assignments to system positions. The responsibility module 408 may then retrieve the system position attribute 808 associated with the information set 802 from the data storage device 104 and determine 608 whether the network participant 212 is authorized to access the information set based on his assigned network position.

In one embodiment, both the exception module 406 and the responsibility module 408 may communicate their respective determinations 606, 608 to the receiver module 402, which may allow the network participant 212 to access the information set 802.

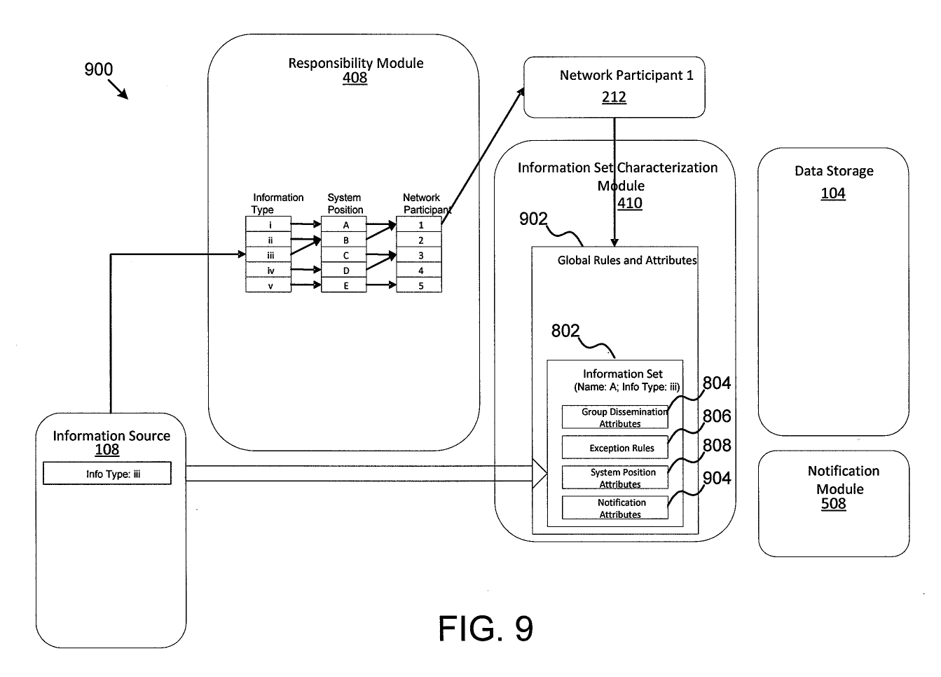

FIG. 9 is a schematic block diagram illustrating one embodiment of a flow of operations for storing an information set 802 in an apparatus 900 for responsibility-based data management. In one embodiment, the apparatus 900 may be configured to publish an information set 802 received from an information source 108 that is outside the network participant network 210. In such an embodiment, the information source 108 may generate an information set 802, and communicate it to the information set characterization module 410. For example, the information source 108 may communicate the information set 802 to the information set characterization module 410 via a web page, a File Transfer Protocol (FTP) site, email, fax, telephone, landline modem, or the like.

The information set characterization module 410 may then assign a name or identifier to the information set 802. The information set characterization module 410 may also assign an information type to the information set 802. For example, as illustrated here, the information set characterization module 410 may assign the name “A” and information type “iii” to the information set 802.

The information set characterization module 410 may then notify the responsibility module 408 that an information set 802 belonging to a specified information type has been proposed for publication to the data storage device 104. The responsibility module 408 may then determine a system position that is associated with the information type. In a further embodiment, the responsibility module 408 may determine that network participant 212 is associated with the identified system position. For example, the responsibility module 408 may determine that, since the information set 802 is characterized as “type iii,” system position “B” is responsible for the information set 802. The responsibility module 408 may further determine that the first network participant 212 is associated with, among others, system position “B.”

In a further embodiment, the responsibility module 408 may notify the network participant 212, via the notification module 508, that the information set 802 is held in the information set characterization module 410 for review.

In a further embodiment, the network participant 212 may review the information set 802 and ascribe the group dissemination attributes 804, the exception rules 806, the system position attributes 806, and the notification attributes 904 in response to the notification. The information set characterization module 410 may then publish the information set 802 to the data storage device 104.

In another embodiment, the apparatus 900 may be configured to publish an information set 802 received from a network participant 212-216 (e.g., the second network participant 214). In such an embodiment, the second network participant 214 may designate the information type that is associated with the information set 802. Otherwise, the process may be substantially the same as that described above.

In still another embodiment, the apparatus 900 may be configured to publish an information set 802 received from a responsible person. For example, if the first network participant 212 is the responsible person, and also the network participant that is submitting the information set 802 for publication, the network participant 212 may designate the system position attributes, the group dissemination attributes, the exception rules, and the notification attributes ascribed to information set 802.

In another alternative embodiment, apparatus 900 may be configured to publish an information set 802 received from an automated information source 108. For example, the automated information source 108 may include a sensor configured to submit a continuous stream of data. In such an embodiment, a responsible person 212 or a network administrator may identify an information source 108 that provides information desired by the network participants 212-216. The network administrator or responsible network participant 212 may additionally designate the information type for the information received from that information source 108.

In such an embodiment, the information set characterization module 410 may hold rules created by a responsible person 212 for breaking the information into information sets 802 and naming or organizing the information sets 802. In a further embodiment, the information set characterization module 410 may hold and apply global 902 group dissemination attributes, exception rules, system position attributes, and notification attributes to be assigned to each information set 802 received by the apparatus 900 from a designated information source 108.

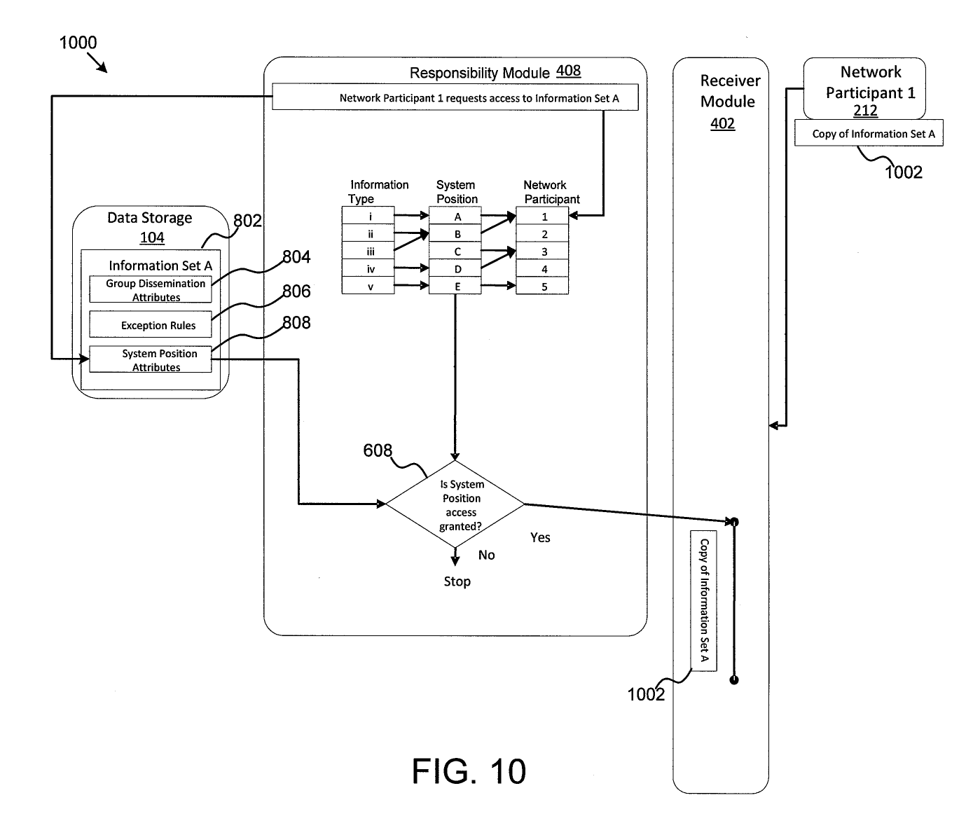

FIG. 10 is a schematic block diagram illustrating one embodiment of a flow of operations for system position-based access of an information set 802 in an apparatus 1000 for responsibility-based data management. In one embodiment, the network participant 212 may submit a request to access the information set 802 to the receiver module 402. The receiver module 402 may pass the request to the responsibility module 408. In a further embodiment, the receiver module 402 may pull a copy 1002 of the information set 802 from the data storage device 104, and hold it, pending a determination as to the network participant's 212 access rights.

The responsibility module 408 may then determine whether any system positions have been assigned to the network participant 212. For example, in this example, the first network participant 212 may be assigned to system positions “A” and “B.” The responsibility module 408 may then confirm the system position attributes 808 that have been assigned to the information set 802. The responsibility module 408 may then determine 608 whether the system positions assigned to the first network participant 212 have access to information set 802, based on the relevant system position attributes 808.

If access is granted, the responsibility module 408 may notify the receiver module 402. The responsibility module 402 may then release access to the copy 1002 of the information set 802 to the first network participant 212.

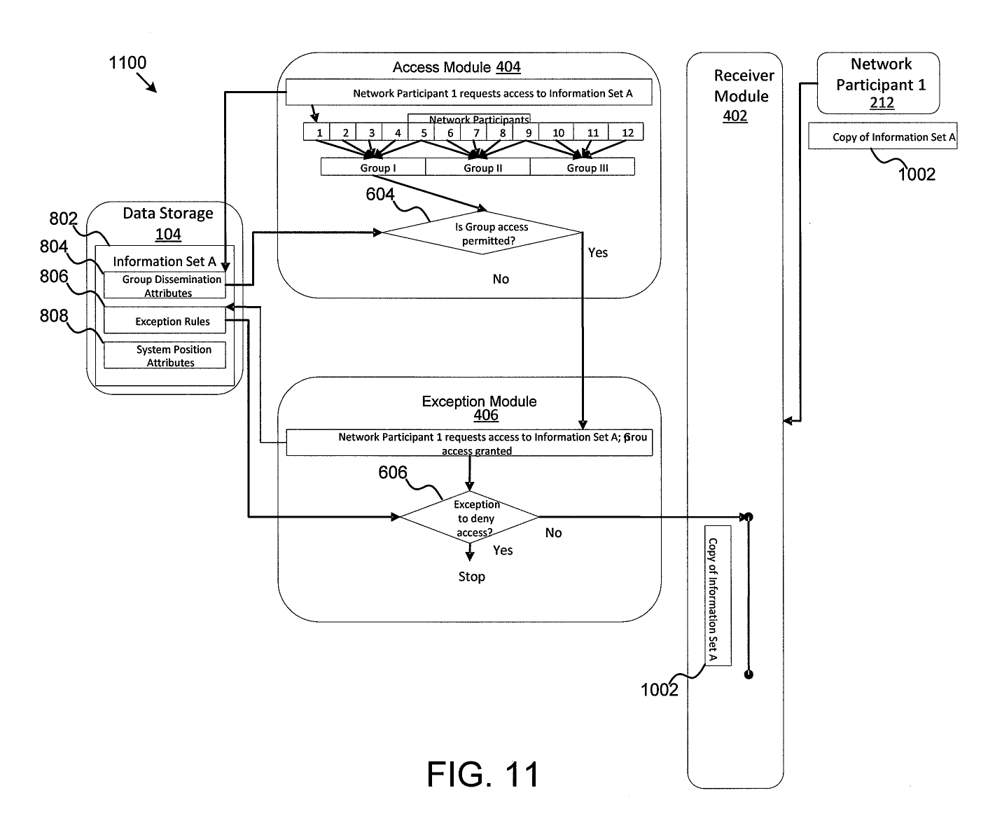

FIG. 11 is a schematic block diagram illustrating one embodiment of a flow of operations for group-based access of an information set 802 in an apparatus 1100 for responsibility-based data management. In one embodiment, the first network participant 212 may submit a request to access the information set 802 to the receiver module 402. The receiver module 402 may then pass the request to the access module 402. In a further embodiment, the receiver module 402 may pull a copy 1002 of the information set 802 from the data storage device 104, and hold it, pending a determination as to the first network participant's 212 access rights.

The access module 404 may then determine a list of groups to which the first network participant 212 belongs. For example, the access module 404 may include logic, tables, or software code configured to determine that the first network participant 212 belongs to a first group. The access module 404 may then confirm the group dissemination attributes 804 that have been assigned to the information set 802. The access module 404 may then determine 604 whether the group to which the network participant 212 has been assigned has access to the information set 802, based on the relevant group dissemination attributes 804. The access module may additionally notify the exception module 406 that the first network participant 212 has requested access to the information set 802, and the results of its determination 604 regarding group access rights (in this example, assume that group access is permitted).

The exception module 406 may then confirm the exception rules 806 that have been assigned to the information set 802 with regard to the first network participant 212. The exception module 406 may then determine 606 whether the first network participant 212 is authorized to access the information set 802, based on any relevant exception rules 806. If an exception rule has been created to deny the first network participant 212 access to the information set 802 notwithstanding any applicable group access rights, the process stops, and the first network participant 212 is not given access to the information set 802.

If an exception rule 806 to deny the first network participant 212 access to the information set 802 has not been created, the exception module 406 may notify the receiver module 402, and the first network participant 212 may be given access to the copy 1002 of the information set 802 held by the receiver module 402.

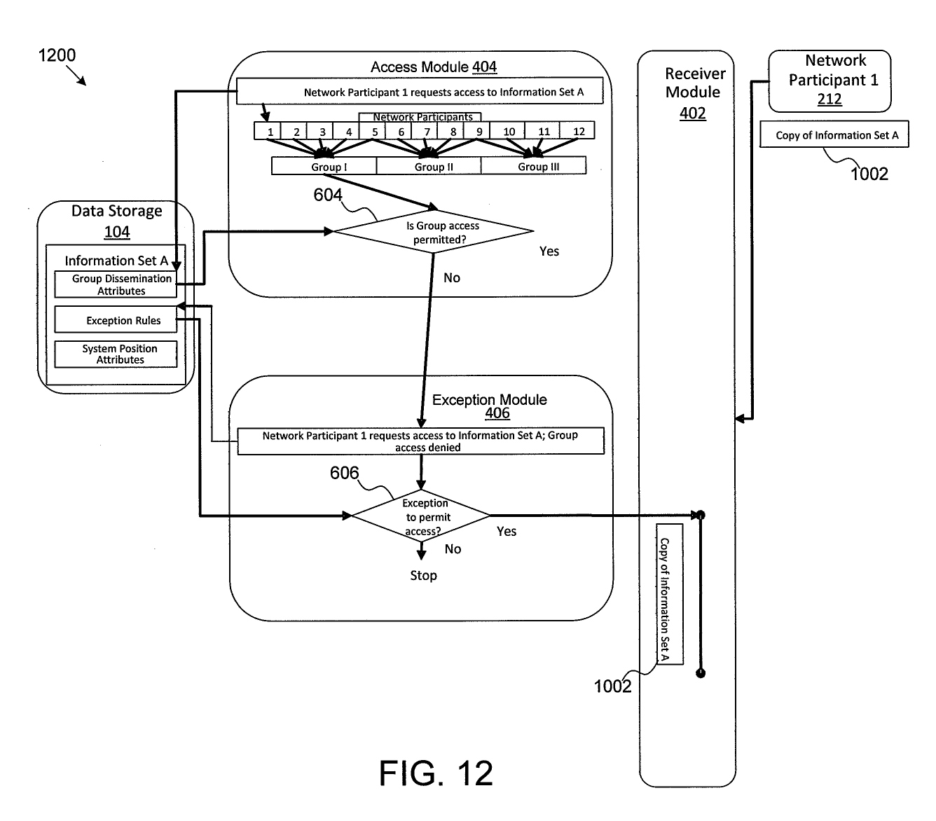

FIG. 12 is a schematic block diagram illustrating another embodiment of a flow of operations for group-based access of an information set 802 in an apparatus 1200 for responsibility-based data management. In one embodiment, the first network participant 212 may submit a request to access the information set 802 to the receiver module 402. The receiver module 402 may then pass the request to the access module 402. In a further embodiment, the receiver module 402 may pull a copy 1002 of the information set 802 from the data storage device 104, and hold it, pending a determination as to the first network participant's access rights.

The access module 404 may then determine a list of groups to which the first network participant 212 belongs. For example, the access module 404 may include logic, tables, or software code configured to determine that the first network participant 212 belongs to a first group. The access module 404 may then confirm the group dissemination attributes 804 that have been assigned to the information set 802. The access module 404 may then determine 604 whether the group to which the network participant 212 has been assigned has access to the information set 802, based on the relevant group dissemination attributes 804. The access module may additionally notify the exception module 406 that the first network participant 212 has requested access to the information set 802, and the results of its determination 604 regarding group access rights (in this example, assume that group access is not permitted).

The exception module 406 may then confirm the exception rules 806 that have been assigned to the information set 802 with regard to the first network participant 212. The exception module 406 may then determine 606 whether the first network participant 212 is authorized to access the information set 802, based on any relevant exception rules 806. If no exception rule 806 has been created to permit the first network participant 212 access to the information set 802, the process stops, and the first network participant 212 is not given access to the information set 802.

If an exception rule 806 has been created to permit the first network participant 212 access to the information set 802, the exception module 406 notifies the receiver module 402, and the first network participant 212 is given access to the copy 1002 of the information set 802 held by the receiver module 402.

### Example Embodiments

A first example embodiment of the apparatus, system, and method described above may be implemented in a care network which is assembled together to care for an aging individual. According to this example, the individual is named George. In this embodiment, the network of individuals helping George include 15 network participants and 9 contact people from differing walks of life and in various locations. Table 1 illustrates an example of a listing of network participants and their associated profile information.

TABLE 1
An example listing of network participants and associated profile
information.

| Name | Type | Location (away) | | Experience/Profession |
|---|---|---|---|---|
| Spouse1 | NP | 2 | Miles | Divorced 2^{nd} |
| | | | | wife/Retired |
| Daughter1 | NP | 3 | Miles | Medical Secretary |
| Daughter2 | NP | 120 | Miles | Housewife |
| Son1 | NP | 600 | Miles | Insurance Agent |
| Son2 | NP | 2100 | Miles | Computer Programmer |
| Soninlaw1 | NP | 3 | Miles | Construction |
| Daughterinlaw2 | NP | 2100 | Miles | Real Estate |
| Brother1 | NP | 250 | Miles | Retired |
| Sister1 | NP | 250 | Miles | Retired |
| Grandaughter1 | NP | 4 | Miles | Registered Nurse |
| Grandson1 | NP | 120 | Miles | Landscaping |
| Grandson2 | NP | 3 | Miles | College Student |
| Neighbor1 | NP | Next Door | | Real Estate Agent |
| Neighbor2 | Contact | Next Door | | Stock Broker |
| Friend1 | NP | 1 | Mile | Retired |
| Friend2 | Contact | 1.5 | Miles | Retired |
| Friend3 | Contact | 4 | Miles | Retired |
| Doctor1 | Contact | 6 | Miles | Primary Care |
| Doctor2 | Contact | 8 | Miles | Cardiologist |
| Doctor3 | Contact | 8 | Miles | Radiologist |
| Clergy1 | Contact | 1 | Mile | Priest |
| Financial Advisor1 | NP | 2 | Miles | Friend/Financial |
| | | | | Planner |
| Accountant1 | Contact | 4 | Miles | CPA |
| Lawyer | Contact | 250 | Miles | Lawyer |

The network may be created using a web application developed by Card Access, Inc. hosted by a server 102. In a further embodiment, the server 102 may be a Dell server configured to run a Linux version 1.6 operating system and connected to the Internet. In this example, the network is given the name of “GeorgeCare.” Upon creation, network participants and contacts are entered into the network, along with their relevant data and preferred notification information. The network participants 212-216 may be provided with login credentials.

Additionally, the network participants 212-216 may be assigned to system positions as described in Table 2. Additionally, the network participants 212-216 may be assigned to groups as shown in Table 3. In this example, the following groups and system positions are created and responsible persons assigned:

TABLE 2
Examples of system position assignments and notification designations.

| | | Sys. Position | |
|---|---|---|---|
| | Responsible | Short | Methods Created by |
| System Position | Person | Name | Network for Data Input |
| Network | Son2 | Admin | Admin.georgecare@mmfcare.com |
| Administrator | | | Fax 480-778-1234 |
| | | | FTP.georgecare@mmfcare.com |
| Sensor Data | Daughter1 | Sensor | Existing Broadband at George's or |
| Manager | | | Cellular Router from Card Access |
| Legal Manager | Son1 | Legal | Legal.georgecare@mmfcare.com |
| Medical Manager | Grandaughter1 | Medical | Medical.georgecare@mmfcare.com |
| | | | Fax 480-778-1235 |
| Property Care | Grandson2 | Property | Property.gerogecare@mmfcare.com |

TABLE 3
Examples of group assignments.

| Group Name | Group Participants |
|---|---|
| Close Family | Daughter1, Daughter2, Son1, Son2 |
| (legal heirs) | |
| Extended Family | Spouse1, Brother1, Sister1, Grandaughter1, |
| | Grandson1, Grandson2, Soninlaw1, |
| | Daughterinlaw2 |
| Friends | Friend1, Friend2, Friend3, Clergy1, Neighbor2 |
| Medical Team | Grandaughter1, Daughter1, Neighbor1, |

In this example, the network administrator may use a web-based application developed by Card Access, Inc. to create the network 106 and establish system positions as shown in Table 2, group designations as shown in Table 3, exception rules, notification attributes, global attributes and other rules for getting data conveniently in and out of the network 106. Email addresses, fax numbers, URLs, and FTP sites may be automatically and dynamically created to allow the network participants 212-216 to easily direct data flow to the data storage device 104. The network administrator or designated network participants 212-216 may govern how data is accessed in the network 106. In one embodiment, the system 100 and/or web application may include highly intuitive controls so that no special technical knowledge is required to set up the network for use by the network participants 212-216.

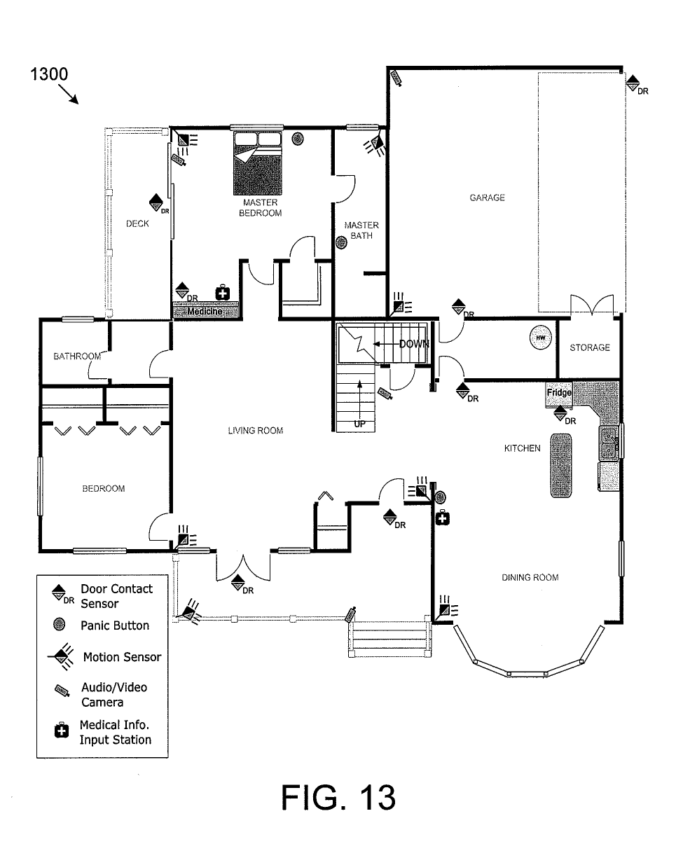

The information being managed in the network 106 may include sensor and medical data from George's home as illustrated in FIG. 13, medical information related to George's condition, legal information related to George's estate, and financial information. Data may be fed into the network 106 automatically from various information sources such as: automated motion and contact sensors (as shown in FIG. 13), medical information input stations (as shown in FIG. 13), direct email publishing, direct fax publishing, direct URL or FTP web posting, or individual network participant publishing. These methods are briefly discussed below to illustrate how the data may be handled in the system 100.

FIG. 13 illustrates an example of a sensor configuration in George's home. The sensors may include door contact sensors, panic buttons, motions sensors, audio/video cameras, and medical information input stations. A medical information input station may include a user terminal for entering medical information such as weight, blood pressure, blood sugar levels, etc. Alternatively, a medical information input station may be an automated medical device configured to automatically communicate measurements and metrics to the system server 102.

In this example, sensor data from George's home may be automatically fed into the network 106 on a real-time basis using existing equipment from Control4, Panasonic, General Electric, and/or Card Access, Inc. Sensors may be placed in George's home by a qualified home automation specialist. FIG. 13 illustrates one example of a layout 1300 for sensor placement.

Contact switches may be used to monitor the opening and closing of doors, the refrigerator, and medicine cabinets. Motion sensors may be used to monitor occupancy and movement in various rooms. Cameras may be used to provide video and audio capabilities as deemed necessary by trusted and responsible network participants. Because of the sensitive nature of some sensor data, the system 100 may provide proper, secure, and appropriate access to such data by limiting access to the data. In this example, access to the audio/video sensor data may be restricted to the “Close Family” group and/or the “Sensor Data Manager” system position.

Data exchanged between the sensor equipment (in George's home) and the server 102 may be protected by a secure Virtual Private Network (VPN) link ensuring complete data security. A Secure Socket Layer (SSL) connection between each network participant 212-216 and the server 102 based web application may further protect data integrity and privacy. Appropriate notifications and data reports may be set up, maintained, and distributed according to access levels granted to, and defined by, the responsible system position given to the network participants 212-216.

Medical data such as blood pressure, blood oxygen level, body temperature, medications taken, general activity level, and general well-being may be collected from a medical information input panel provided by Card Access, Inc. Information from this panel may be automatically fed into the network 106 on a real-time basis as it is taken or entered.

Custom email addresses maybe created by the server 102 or a network participant 212 to allow easy publishing of data into the network 106 by participants and non-participants alike. For example, George may ask a doctor to email a medical lab report to “medical.georgecare@mmfcare.com” or to fax the report to 480-778-1235 (both assigned and maintained by the server 102 or a network participant 212). The report may be automatically received into the network 106 and put into a holding area for review by the assigned system position (in this example, assigned to Grandaughter1). Grandaughter1 may then review, grant appropriate access rights, and publish the report into the network 106 for storage. The doctor can feel confident that he is following appropriate HIPPA laws by receiving an authorization letter (produced by the network 106) to send the requested report. The network administrator and system position managers are then responsible for appropriate information security and distribution. The server 102, and specifically the tracking module 502 and/or the logging module 504, may track and maintain time-based records of who holds system positions.

A URL and FTP site may be created automatically by the server 102 or a network participant 212 through the server 102 to allow for the posting of various types of data by network participants 212-216 and non-network participants. For example, a network participant 212 can go to the assigned FTP site and post various file types that they would like to be stored in the GeorgeCare network 106. Likewise, a network participant 212 can give out the web URL or FTP site to a trusted non-network participant for convenient access to posting of files to the network 106. Various file types, such as pictures, audio files or video files, may be posted. These files may be automatically routed by the server 102 to the appropriate responsible system position who would review, grant appropriate access rights to network participants 212-216, and publish the files into the data storage device 104 for storage. URL and FTP network services would mainly be used for transferring large files by network participants 212-216 and non-network participants. This allows for a convenient method for those involved in George's care to post important files relating to his health and well being.

Once a network participant 212 has logged onto the web application or server 102, he/she will be given several options to post various files into the network 106 in a convenient, easy-to-use manner.

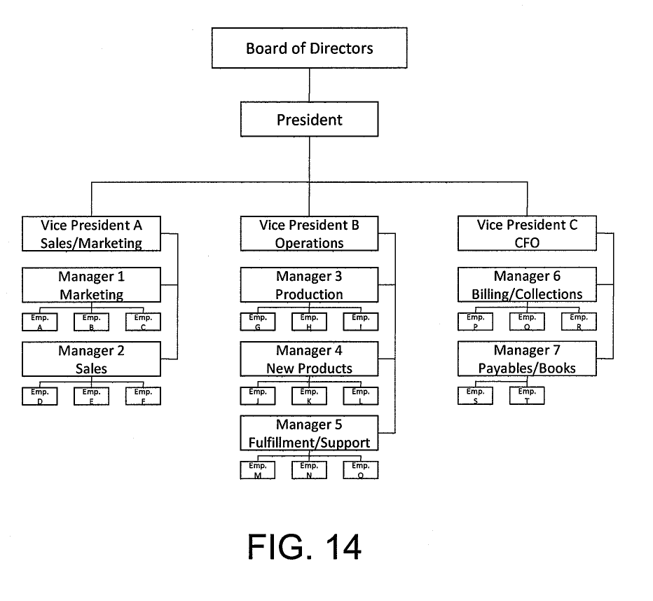

A second example embodiment of the apparatus, system, and method described above occurs in a corporate setting. Most corporations in the United States with 10 or more employees are organized generally as shown in FIG. 14. The organization typically includes a board of directors, officers, department heads and middle management, and employees. The board of directors is formed to assume top-level responsibility for, and provided strategic guidance and direction to, the corporation and its operations. The President and/or Chief Executive Officer (CEO) is appointed to run the day-to-day operations of the corporation and assume responsibility for implementing decisions made by the board. Vice presidents are appointed to assume responsibility for designated departments of the corporation, and for implementing those strategies that relate to their departments. As necessary, each department may be further divided into sections or divisions, and a manager is appointed to assume responsibility for each such section or division. FIG. 14 shows, in organizational-chart format, a representative corporation organized along these lines.

In this example, the network 106, 210 is the collection of corporate employees working together to conduct the business of the corporation. Each employee is a network participant 212. Information sets 802 may include any information that is relevant to the operation of the corporation, and may include, for example, documents, agreement forms, copies of executed documents, spreadsheet files and memoranda. The network administrator could be anyone in the corporation, not necessarily the individual responsible for maintaining the corporation's physical network of computers and related equipment. In this example, the network administrator may, among other things have an understanding of the manner in which the corporation is functionally structured, and be current relative to new employees hired and employees who, for whatever reason, have left the corporation, and where each employee fits within the corporate structure. For example, a human resource manager may be the network administrator.

Information types may be designated by the network administrator, and may be classified along lines that mirror the functional structure of the corporation. For example, a corporation that develops and sells consumer software products might have information types that include: (i) marketing information; (ii) sales and demand planning information; (iii) facilities management information; (iv) human resources information; (v) legal/compliance information; (vi) customer fulfillment and product support information; (vii) new product development information; (viii) billing and collection information; (ix) accounts payable and tax information; (x) product production information; (xi) inventory information; (xii) board information; (xiii) general financial information; and (xiv) everything else.

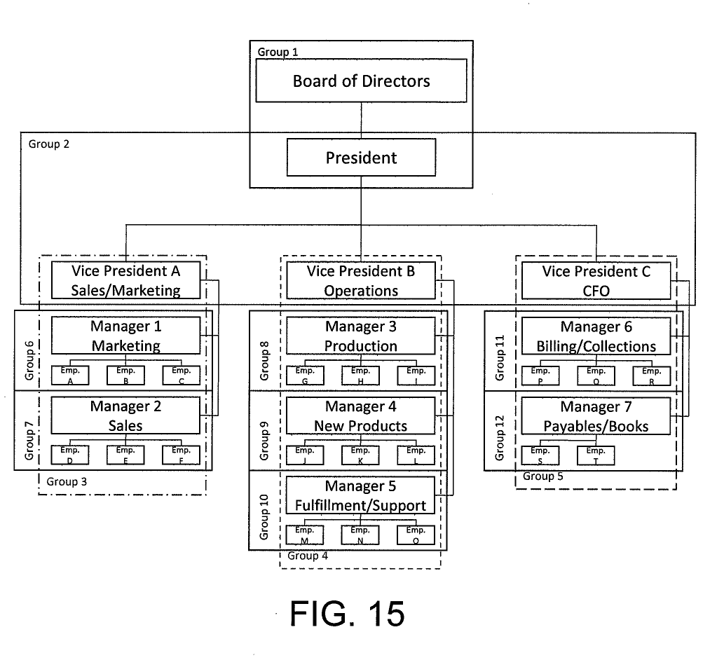

The network administrator may divide the network participants into groups, the members of which may be granted generally similar rights to access information sets as a result of commonalities in the role(s) they play in the fulfillment of the purposes of the corporation. Given the structure in the example above, it may be logical to divide the corporation's employees into groups along organizational lines, as shown in Table 4 and further illustrated in FIG. 15.

TABLE 4
Examples of group designations according to corporate organization.

| | |
|---|---|
| Group 1: | Board of Directors and President |
| Group 2: | Executive Officers (President and Vice Presidents) |
| Group 3: | Sales and Marketing |
| Group 4: | Operations |
| Group 5: | Accounting |
| Group 6: | Marketing |
| Group 7: | Sales |
| Group 8: | Production |
| Group 9: | New Products |
| Group 10: | Fulfillment/Support |
| Group 11: | Billing/Collections |
| Group 12: | Payables/Books |

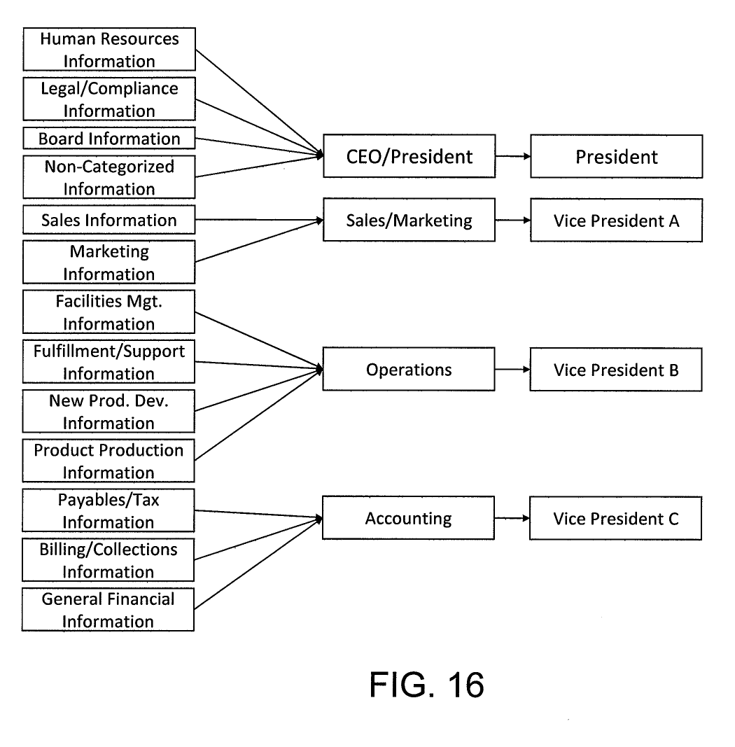

After dividing the information received or generated and processed by the corporation into information types, the information types may be assigned to a system position, making that system position responsible for the handling, characterization and custody of all corporate information of that information type. In this example, an information type may be assigned to a single system position; however one system position may have multiple information types assigned to it. In the corporation used in this example, it may be logical to have at four (4) system positions: (i) CEO/President; (ii) Sales/Marketing; (iii) Operations; and (iv) CFO. Depending upon the number of information sets associated with any one information type in this example, the network administrator may add additional system positions to allow a further delegation of responsibility. Given the representative information types and system positions described above, the network administrator may assign the information types described above to those system positions, and to assign those system positions to network participants, as described in FIG. 16.

According to the present example, in preparation for a meeting of the board of directors, the President may request that, among other things, Vice President B prepare a report that describes all material operations-related activity that occurred in the last calendar quarter. Vice President B may delegate to each of his managers the task of preparing a report that relates to such manager's department, which Vice President B will then use to prepare the board report requested of him. Manager 3 may then prepare a report describing production activity, Manager 4 may prepare a report describing new product activity, and Manager 5 may prepare a report describing fulfillment/support activity.

Since none of Managers 3, 4 or 5 have been given, in this example, system positions, each Manager may publish the report he/she prepared into the data storage device 104, being able only to designate its information type. Manager 4 may classify her report as “New Product Development Information.” When Manager 4 publishes her report into the system, the system may notify Vice President B (since he is the network participant to whom the Operations system position has been assigned, and the Operations system position is the system position to which the New Product Development information type has been assigned) that Manager 4's report is now in the system, and ready for him to determine who else in the corporation should have access to it.

Assume that, upon reviewing Manager 4's report, Vice President B determines that, given its detail: (i) it would be useful for the other members of Manager 4's department, and the members of Manager 3's department, to see it; (ii) it is relevant to sales/marketing system position; and (iii) Manager 1, individually, should see it. As such, Vice President B would, in the information set characterization module: (a) ascribe to the report group dissemination attributes that authorize Groups 8 and 9 to access the report; (b) create an exception rule that allows Manager 1 to access the report; and (c) ascribe to the report a system position attribute that makes it available to the sales/marketing system position.

Under these circumstances, if a new employee is added to the corporation's Production Department, that new employee will automatically have access to Manager 4's report. In addition, if the sales/marketing system position shifts to a different employee for any reason (if, for example, Vice President A quits, or goes on vacation for an extended period of time), the right to access Manager 4's report automatically shifts to the network participant to whom that system position is assigned.

Assume that Vice President C has established, for the corporation, an number of on-line accounts with banks, suppliers and the IRS that allow him to accomplish certain of his duties over the Internet. Further, assume that, in the creation of these on-line accounts, Vice President C recognizes that the account numbers/user names and passwords are corporate, not personal, property and, as such, publishes them into the system without providing any group dissemination attributes or exception rules, making them available only to the Accounting system position.

In such an embodiment, only the employee to whom the Accounting system position is assigned may have access to those user names/account numbers and passwords. This may ensure that confidential and sensitive information is available only to the appropriate employee, and that if the employee leaves or is unavailable for any reason, and the system position is assigned to another employee, this confidential and sensitive information may be available to the second employee, without needing to sort through any files or make phone calls to Vice President C (who may be unavailable or uncooperative) to try to get the information from him.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method comprising:
receiving a request, from a network participant, to access an information set;
setting a permission indicator in response to a determination that the network participant is associated with a group dissemination attribute that authorizes the network participant to access the information set;
modifying the permission indicator in response to a determination that an exception rule modifies the group dissemination attribute;
setting the permission indicator in response to a determination that the network participant is associated with a system position attribute that authorizes the network participant to access the information set; and
providing access to the information set in response to a determination that the permission indicator authorizes the network participant to access the information set.

2. The method of claim 1, further comprising:
identifying an association between the network participant and a group;
retrieving the group dissemination attribute associated with the information set; and
setting the permission indicator in response to a determination that the group dissemination attribute authorizes the network participant to access the information set based on the association between the network participant and the group.

3. The method of claim 1, further comprising:
locating an exception rule that applies to the network participant and to the information set;
modifying the permission indicator to deny the network participant access to the information set in response to a determination that the exception rule prohibits the network participant from accessing the information set; and
modifying the permission indicator to grant the network participant access to the information set in response to a determination that the exception rule authorizes the network participant to access the information set.

4. The method of claim 1, further comprising:
identifying a system position to which the network participant has been assigned;
retrieving the system position attribute associated with the system position; and
setting the permission indicator in response to a determination that the system position attribute authorizes the network participant to access the information set.

5. The method of claim 1, further comprising tracking a transfer of a system position from a first network participant to a second network participant.

6. The method of claim 1, further comprising generating a log of service data associated with a system position.

7. A method comprising:
receiving an information set for dissemination;
setting a group dissemination attribute that authorizes a group of network participants to access the information set;
establishing an exception rule configured to modify the group dissemination attribute in response to a special access requirement; and
setting a system position attribute that authorizes a predetermined system position to access the information set.

8. The method of claim 7, further comprising automatically setting the group dissemination attribute, establishing the exception rule, and setting the system position attribute.

9. The method of claim 7, further comprising storing the group dissemination attribute, the exception rule, and the system position attribute ascribed to the information set.

10. The method of claim 7, further comprising sending a notification to a predetermined network participant in response to a selected event associated with the information set.

11. An apparatus comprising:
a receiver module configured to receive, from a network participant, a request to access an information set, and to provide access to the information set in response to a determination that a permission indicator authorizes the network participant to access the information set;
an access module in data communication with the receiver module, the access module configured to set the permission indicator in response to a determination that the network participant is associated with a group dissemination attribute that authorizes the network participant to access the information set;
an exception module in data communication with the access module, the exception module configured to modify the permission indicator in response to a determination that an exception rule modifies the group dissemination attribute; and
a responsibility module in data communication with the receiver module, the responsibility module configured to set the permission indicator in response to a determination that the network participant is associated with a system position attribute that authorizes the network participant to access the information set.

12. The apparatus of claim 11, the access module further configured to:
identify an association between the network participant and a group;
retrieve the group dissemination attribute associated with the information set; and
set the permission indicator in response to a determination that the group dissemination attribute authorizes the network participant to access the information set based on the association between the network participant and the group.

13. The apparatus of claim 11, the exception module further configured to:
locate an exception rule that applies to the network participant and to the information set;
modify the permission indicator to deny the network participant access to the information set in response to a determination that the exception rule prohibits the network participant from accessing the information set; and
modify the permission indicator to grant the network participant access to the information set in response to a determination that the exception rule authorizes the network participant to access the information set.

14. The apparatus of claim 11, the responsibility module further configured to:
identify a system position to which the network participant has been assigned;
retrieve the system position attribute associated with the system position; and
set the permission indicator in response to a determination that the system position attribute authorizes the network participant to access the information set.

15. The apparatus of claim 11, the responsibility module further comprising a tracking module configured to track a transfer of a system position from a first network participant to a second network participant.

16. The apparatus of claim 11, the responsibility module further comprising a logging module configured to generate a log of service data associated with a system position.

17. The apparatus of claim 11, further comprising a notification module configured to send a notification to a predetermined network participant in response to a selected event associated with the information set.

18. An apparatus comprising:
a receiver module configured to receive an information set for dissemination; and
an information set characterization module in data communication with the receiver module, the information set characterization module configured to:
set a group dissemination attribute that authorizes a group of network participants to access the information set;
establish an exception rule configured to modify the group dissemination attribute in response to a special access requirement; and
set a system position attribute that authorizes a predetermined system position to access the information set.

19. The apparatus of claim 18, further comprising a data storage device coupled to the information set characterization module, the data storage device configured to store the group dissemination attribute, the exception rule, and the system position attribute ascribed to the information set.

20. A system comprising:
a data storage device configured to store an information set; and
a server coupled to the data storage device, the server comprising:
a receiver module configured to receive, from a network participant, a request to access an information set, and to provide access to the information set in response to a determination that a permission indicator authorizes the network participant to access the information set;
an access module in data communication with the receiver module, the access module configured to set the permission indicator in response to a determination that the network participant is associated with a group dissemination attribute that authorizes the network participant to access the information set;
an exception module in data communication with the access module, the exception module configured to modify the permission indicator in response to a determination that an exception rule modifies the group dissemination attribute; and
a responsibility module in data communication with the receiver module, the responsibility module configured to set the permission indicator in response to a determination that the network participant is associated with a system position attribute that authorizes the network participant to access the information set.

21. The system of claim 20, where the receiver module is further configured to receive an information set for dissemination.

22. The system of claim 21, the server further comprising an information set characterization module in data communication with the receiver module, the information set characterization module configured to:
receive an information set for dissemination;
set a group dissemination attribute that authorizes a group of network participants to access the information set;
establish an exception rule configured to modify the group dissemination attribute in response to a special access requirement; and
set a system position attribute that authorizes a predetermined system position to access the information set.

23. A computer program product comprising a computer-readable medium having computer-readable instructions executable to perform operations comprising:
receiving a request, from a network participant, to access an information set;
setting a permission indicator in response to a determination that the network participant is associated with a group dissemination attribute that authorizes the network participant to access the information set;
modifying the permission indicator in response to a determination that an exception rule modifies the group dissemination attribute;
setting the permission indicator in response to a determination that the network participant is associated with a system position attribute that authorizes the network participant to access the information set; and
providing access to the information set in response to a determination that the permission indicator authorizes the network participant to access the information set.

24. The computer program product of claim 23, the instructions further comprising:
receiving an information set for dissemination;
setting a group dissemination attribute that authorizes a group of network participants to access the information set;
establishing an exception rule configured to modify the group dissemination attribute in response to a special access requirement; and
setting a system position attribute that authorizes a predetermined system position to access the information set.
